(19) United States
(12) Patent Application Publication
(10) Pub. No.: US 2025/0292304 A1
(43) Pub. Date: Sep. 18, 2025

(54) Context Extraction of Event-Based Data

(71) Applicant: ClarityQ Ltd., Ramot Hashavim (IL)

(72) Inventors: Aviad Ashkenazi, Givatayim (IL); Yaron Segalov, Even Yehuda (IL); Orly Shoavi, Herzliya (IL); Ronnie Sternberg, Ramot Hashavim (IL)

(21) Appl. No.: 19/078,174

(22) Filed: Mar. 12, 2025

Related U.S. Application Data
(60) Provisional application No. 63/564,082, filed on Mar. 12, 2024.

(51) Int. Cl. G06Q 30/0601; G06F 8/41; G06F 8/75; G06F 16/2455

(52) U.S. Cl. CPC G06Q 30/0627; G06F 8/433; G06F 8/75; G06F 16/2455

(57) ABSTRACT

A method, product, and apparatus for performing automated data analysis of a digital product, comprising: obtaining an inquiry representing a data analysis task associated with the digital product; performing the data analysis task automatically based on a database of the digital product by: generating a prompt for a language model based on the inquiry and based on event context data that comprises a plurality of event entries and sub-entries for parameters of the event, an entry comprises a name of an event and a textual description of the event, said generating comprises incorporating within the prompt an instruction to generate a data query; feeding the prompt to the language model; obtaining the data query; executing the data query over the database; and determining data values based on said executing; and presenting an answer to the inquiry.

### CROSS-REFERENCE TO RELATED APPLICATION

This application claims the benefit of Provisional Patent Application No. 63/564,082, entitled “Context Extraction of Event-based Data” filed Mar. 12, 2024, which is hereby incorporated by reference in its entirety without giving rise to disavowment.

### TECHNICAL FIELD

The present disclosure relates to event analysis in general, and to use of Large Language Modes (LLMs) for extracting contextual information of events, in particular.

### BACKGROUND

Advancements in artificial intelligence and natural language processing have led to the development of sophisticated models capable of understanding, generating, and processing natural language at an unprecedented scale. For example, a language model such as a Large Language Model (LLM) or a Small Language Model (SML) constitutes an advanced machine learning model trained on vast amounts of textual data, enabling it to comprehend and generate human-like text in a variety of languages. These models employ deep neural network architectures to learn patterns, semantics, and contextual information from textual inputs, enabling them to perform tasks such as language translation, text summarization, sentiment analysis, and even creative writing.

By leveraging their vast knowledge base and language proficiency, language models such as LLMs have the potential to revolutionize various fields, including content generation, customer support, language understanding, and information retrieval, among others. Their versatile capabilities make LLM an invaluable tool for businesses and researchers seeking to harness the power of natural language processing in their applications. Several notable examples of publicly available LLM products are ChatGPT™, BARD™ and BING™ Chat.

### BRIEF SUMMARY

One exemplary embodiment of the disclosed subject matter is a method of performing automated data analysis of a digital product, the method comprising: obtaining an inquiry regarding the digital product, the inquiry representing a data analysis task associated with the digital product; performing the data analysis task automatically, said performing comprises: generating a prompt for a language model, the prompt is generated based on the inquiry and based on event context data that is pre-prepared, the event context data comprises a plurality of entries, wherein an entry of the plurality of entries comprises a name of an event of the digital product and a textual description of the event, wherein the event context data comprises sub-entries for parameters of the event, wherein a sub-entry of a parameter comprises a name of the parameter and a textual description of the parameter, wherein the event context data is generated automatically based on one or more data sources associated with the digital product, the one or more data sources comprising at least a database of the digital product, wherein said generating comprises incorporating within the prompt an instruction to generate a data query based on the inquiry and based on the event context data; feeding the prompt to the language model, thereby instructing an engine of the language model generate the data query in view of the prompt; in response to said feeding, obtaining the data query from the language model; executing the data query over the database of the digital product; and determining one or more data values associated with the database based on said executing; and presenting an answer to the inquiry, wherein the answer represents the one or more data values.

Optionally, the method is performed automatically by a data analysis platform.

Optionally, the inquiry is obtained via a natural language interface of the data analysis platform, the inquiry comprises a natural language question that is submitted by a user of the data analysis platform.

Optionally, the method comprises obtaining a second inquiry via a structured interface of the data analysis platform, the structured interface is absent of a natural language interface, the second inquiry representing a second data analysis task of the digital product; retrieving from the data analysis platform a second data query that is configured to implement the second data analysis task, the second data query is pre-prepared by the data analysis platform; executing the second data query over the database of the digital product; determining one or more second data values associated with the database based on said executing the second data query; and presenting a second answer to the second inquiry, wherein the second answer represents the second data values, whereby the second data analysis task is performed with greater efficiency compared to the data analysis task at least since the second data query is pre-prepared.

Optionally, the second inquiry is generated by the data analysis platform without user input.

Optionally, the method further comprises preparing the event context data before said obtaining the inquiry, said preparing the event context data comprising: generating a call graph from a source code of the digital product, the call graph representing function invocations; identifying events of the digital product, the events comprising the event; identifying a firing function that fires the event; traversing the call graph from a node that represents the firing function and backwards, thereby obtaining a chain of functions that leads to the firing function; and utilizing a second language model to generate the textual description of the event based on the chain of functions, wherein the second language model is identical or different from the language model.

Optionally, the method of further comprises processing the source code of the digital product to generate summaries of each code unit of the source code, whereby obtaining summaries of the chain of functions, and utilizing the second language model to generate the textual description of the event based on the summaries of the chain of functions

Optionally, the method further comprises utilizing the second language model to generate the textual description of the event based on an events graph that represents precedence relationships between the events, wherein the events graph is generated based on event logs that are stored in a data warehouse of the digital product, wherein the database comprises the data warehouse.

Optionally, said generating the prompt comprises incorporating in the prompt statistical data regarding the events, wherein the statistical data is generated based on the events graph.

Optionally, the method further comprises utilizing the second language model to generate the textual description of the event based on Business Intelligence (BI) data regarding the digital product as extracted from one or more BI tools, documentation data regarding the digital product, historic queries regarding the digital product, examples of accurate data queries, or the like.

Optionally, the examples of the accurate data queries are applicable to a data warehouse of the digital product, wherein the database comprises the data warehouse, wherein the examples comprise historic examples or synthesized examples, the synthesized examples comprise manually generated examples that are provided to the data analysis platform by a user, or automatically generated examples.

Optionally, the documentation data comprises design documents of the digital product, online descriptions of the digital product, project management data of the digital product, End-to-End (E2E) testing specifications for the digital product, screenshots of interactions with the digital product, video clips of interactions with the digital product, or the like, wherein the online descriptions are extracted from a web-based digital application marketplace.

Optionally, the method further comprises generating the sub-entry for the parameter of the event by: identifying a generating function that defines or initiates the parameter; traversing the call graph from a second node that represents the generating function and backwards, thereby obtaining a first chain of functions that leads to the generating function; traversing the call graph from the second node that represents the generating function and forwards at least until reaching the node that represents the firing function, thereby obtaining a second chain of functions that leads to the firing function; and generating the textual description of the parameter based on the first and second chains of functions or summaries of the first and second chains of functions.

Optionally, the method further comprises preparing the event context data before said obtaining the inquiry, said preparing the event context data comprising: generating an events graph based on event logs that are stored in a data warehouse of the digital product, wherein the database comprises the data warehouse, wherein the events graph represents precedence relationships between events of the digital product; and utilizing a second language model to generate the textual description of the event based on the events graph, whereby enabling to prepare the event context data without the source code of the digital product, wherein the second language model is identical or different from the language model. Optionally, said generating the prompt comprises incorporating in the prompt statistical data regarding the events, wherein the statistical data is generated based on the events graph. Optionally, the method further comprises utilizing the second language model to generate the textual description of the event based on BI data regarding the digital product as extracted from one or more BI tools, documentation data regarding the digital product, historic queries regarding the digital product, examples of accurate data queries, or the like. Optionally, the examples of the accurate data queries are applicable to the data warehouse of the digital product, wherein the examples comprise historic examples or synthesized examples, the synthesized examples comprise manually generated examples that are provided to the data analysis platform by a user, or automatically generated examples. Optionally, the documentation data comprises design documents of the digital product, online descriptions of the digital product, project management data of the digital product, E2E testing specifications for the digital product, screenshots of interactions with the digital product, video clips of interactions with the digital product, or the like, wherein the online descriptions are extracted from a web-based digital application marketplace. Optionally, the method further comprises generating the sub-entry for the parameter of the event based on the event logs.

Optionally, the method further comprises preparing the event context data before said obtaining the inquiry, said preparing the event context data comprising: utilizing a second language model to generate the textual description of the event based on BI data regarding the digital product, wherein the BI data is extracted from one or more BI tools, wherein the second language model is identical or different from the language model. Optionally, the method further comprises utilizing the second language model to generate the textual description of the event based on an events graph that represents precedence relationships between the events, wherein the events graph is generated based on event logs that are stored in a data warehouse of the digital product, wherein the database comprises the data warehouse. Optionally, said generating the prompt comprises incorporating in the prompt statistical data regarding the events, wherein the statistical data is generated based on the events graph. Optionally, the method further comprises utilizing the second language model to generate the textual description of the event based on documentation data regarding the digital product, historic queries regarding the digital product, examples of accurate data queries, source code of the digital product, or the like. Optionally, the examples of the accurate data queries are applicable to the data warehouse, wherein the examples comprise historic examples or synthesized examples, the synthesized examples comprise manually generated examples that are provided to the data analysis platform by a user, or automatically generated examples. Optionally, the documentation data comprises design documents of the digital product, online descriptions of the digital product, project management data of the digital product, E2E testing specifications for the digital product, screenshots of interactions with the digital product, video clips of interactions with the digital product, or the like, wherein the online descriptions are extracted from a web-based digital application marketplace. Optionally, the method further comprises generating the sub-entry for the parameter of the event based on the BI data.

Optionally, the method further comprises preparing the event context data before said obtaining the inquiry, said preparing the event context data comprising: utilizing a second language model to generate the textual description of the event based on documentation data regarding the digital product, wherein the second language model is identical or different from the language model. Optionally, the documentation data comprises design documents of the digital product, online descriptions of the digital product, project management data of the digital product, E2E testing specifications for the digital product, screenshots of interactions with the digital product, video clips of interactions with the digital product, or the like, wherein the online descriptions are extracted from a web-based digital application marketplace. Optionally, the method further comprises utilizing the second language model to generate the textual description of the event based on an events graph that represents precedence relationships between the events, wherein the events graph is generated based on event logs that are stored in a data warehouse of the digital product, wherein the database comprises the data warehouse. Optionally, said generating the prompt comprises incorporating in the prompt statistical data regarding the events, wherein the statistical data is generated based on the events graph. Optionally, the method further comprises utilizing the second language model to generate the textual description of the event based on BI data regarding the digital product as extracted from one or more BI tools, historic queries regarding the digital product, examples of accurate data queries, or the like. Optionally, the examples of the accurate data queries are applicable to the data warehouse, wherein the examples comprise historic examples or synthesized examples, the synthesized examples comprise manually generated examples that are provided to the data analysis platform by a user, or automatically generated examples. Optionally, the method further comprises generating the sub-entry for the parameter of the event based on the documentation data.

Optionally, the sub-entries for the parameters of the event context data indicate one or more values of the parameters of the event and one or more textual descriptions of the one or more values.

Another exemplary embodiment of the disclosed subject matter is an apparatus comprising a processor and coupled memory, said processor being adapted to perform: obtaining an inquiry regarding the digital product, the inquiry representing a data analysis task associated with the digital product; performing the data analysis task automatically, said performing comprises: generating a prompt for a language model, the prompt is generated based on the inquiry and based on event context data that is pre-prepared, the event context data comprises a plurality of entries, wherein an entry of the plurality of entries comprises a name of an event of the digital product and a textual description of the event, wherein the event context data comprises sub-entries for parameters of the event, wherein a sub-entry of a parameter comprises a name of the parameter and a textual description of the parameter, wherein the event context data is generated automatically based on one or more data sources associated with the digital product, the one or more data sources comprising at least a database of the digital product, wherein said generating comprises incorporating within the prompt an instruction to generate a data query based on the inquiry and based on the event context data; feeding the prompt to the language model, thereby instructing an engine of the language model generate the data query in view of the prompt; in response to said feeding, obtaining the data query from the language model; executing the data query over the database of the digital product; and determining one or more data values associated with the database based on said executing; and presenting an answer to the inquiry, wherein the answer represents the one or more data values.

Yet another exemplary embodiment of the disclosed subject matter is a computer program product comprising a non-transitory computer readable medium retaining program instructions, which program instructions when read by a processor, cause the processor to perform a method comprising: obtaining an inquiry regarding the digital product, the inquiry representing a data analysis task associated with the digital product; performing the data analysis task automatically, said performing comprises: generating a prompt for a language model, the prompt is generated based on the inquiry and based on event context data that is pre-prepared, the event context data comprises a plurality of entries, wherein an entry of the plurality of entries comprises a name of an event of the digital product and a textual description of the event, wherein the event context data comprises sub-entries for parameters of the event, wherein a sub-entry of a parameter comprises a name of the parameter and a textual description of the parameter, wherein the event context data is generated automatically based on one or more data sources associated with the digital product, the one or more data sources comprising at least a database of the digital product, wherein said generating comprises incorporating within the prompt an instruction to generate a data query based on the inquiry and based on the event context data; feeding the prompt to the language model, thereby instructing an engine of the language model generate the data query in view of the prompt; in response to said feeding, obtaining the data query from the language model; executing the data query over the database of the digital product; and determining one or more data values associated with the database based on said executing; and presenting an answer to the inquiry, wherein the answer represents the one or more data values.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary flowchart diagram of a method, in accordance with some exemplary embodiments of the disclosed subject matter;

FIG. 2 shows an exemplary data dependency graph, in accordance with some exemplary embodiments of the disclosed subject matter;

FIG. 3A shows exemplary insights and alerts regarding a digital product, in accordance with some exemplary embodiments of the disclosed subject matter;

FIGS. 3B-3C show screenshots of an exemplary user interface for performing data analysis tasks, in accordance with some exemplary embodiments of the disclosed subject matter;

FIGS. 4A-4E show screenshots of an exemplary user interface for presenting results from data analysis tasks, in accordance with some exemplary embodiments of the disclosed subject matter;

FIGS. 5A-5B show screenshots of an exemplary event catalog, in accordance with some exemplary embodiments of the disclosed subject matter;

FIG. 6 shows a schematic illustration of an exemplary architecture in which the disclosed subject matter may be utilized, in accordance with some exemplary embodiments of the disclosed subject matter; and

FIG. 7 shows a schematic illustration of an exemplary environment in which the disclosed subject matter may be utilized, in accordance with some exemplary embodiments of the disclosed subject matter.

### DETAILED DESCRIPTION

One technical problem dealt with by the disclosed subject matter is improving the efficiency of data analysis processes. Data analysis processes are often time-consuming and computationally expensive, particularly when handling large-scale datasets or real-time analytics. These processes require specialized expertise, making it difficult to derive meaningful insights without extensive training or reliance on data scientists. In some cases, data analysis often involves multiple stakeholders within a company, leading to delays and increased resource consumption due to coordination challenges and differing expertise levels. The dependency on manual labor further introduces biases and inaccuracies, potentially leading to hindered efficiency, flawed conclusions, suboptimal business strategies, and lacking the accuracy required for solid product decision-making. It may be desired to make the data analysis process less time-consuming, more precise, and less resource-intensive.

Another technical problem dealt with by the disclosed subject matter is to automatically support product decision-making that is data-driven. For example, it may be desired to support organizations with analyzing their digital assets, in order to enable them to perform informed data-driven decisions for their products.

Yet another technical problem dealt with by the disclosed subject matter is to provide clients with automatic answers to product-related inquiries. In some exemplary embodiments, clients may have questions about their digital product, its performance, its deployment, its issues, or any other data-driven questions. For example, clients would like to know which way of presenting an advertisement over a page of their digital product results with the highest conversion rate. It may be desired to enable the clients to inquire about any topic that is related to their product via inquiries, and to provide them with accurate data-driven answers automatically, e.g., without the intervention of a data analyst. For example, it may be desired to enable users of a client to define sophisticated data-based questions regarding the client's product, and to extract in real time product data that complies with the data-based questions.

Yet another technical problem dealt with by the disclosed subject matter is to enhance the human-machine interface by enabling users without training to easily understand and make use of their product's data, e.g., using a natural language interface for data interaction. It may be desired to expand the capabilities of data analysis interfaces to enable them to provide meaningful feedback to inquiries that end users provide. In some cases, generating text with meaningful answers, meaning feedback, or the like, may pose a significant challenge, at least since such tasks require a high level of data analysis capabilities as well as text generation capabilities. It may be desired to overcome these challenges.

Yet another technical problem dealt with by the disclosed subject matter is to enable automated extraction of data-based insights, alerts, or the like, regarding a digital product, such as for product managers. For example, it may be desired to enhance an analysis of product data in order to generate meaningful insights about product usage, customer preferences, potential issues, product problems and opportunities in future product developments, to streamline a Product Requirement Document (PRD) creation, or the like, without necessarily requiring a user interaction in order to initiate the generation of the data-based insights, alerts, or the like.

Yet another technical problem dealt with by the disclosed subject matter is to enable automatic data maintenance, such as automated checks for data quality and consistency. It may be desired to identify anomalies, redundancies, and gaps in data collection in order to address these issues proactively, leading to a cleaner, more reliable dataset that can support more accurate analyses and decisions.

One technical solution provided by the disclosed subject matter may be to perform an event-based analysis of data sources of each digital product, as a pre-preparation step. For example, a data analysis platform may perform the event-based analysis before it enables users to submit inquiries. In some exemplary embodiments, the event-based analysis may be configured to generate an event catalog that can be used for automating a plurality of data-driven tasks.

In some exemplary embodiments, a client may have a digital asset, such as one or more applications, programs, webpages, or the like, for enabling end users to perform digital tasks, interactions, content consumption, or the like. For the purposes of this disclosure, the term ‘program’ shall be understood to include an ‘application,’ and vice versa, unless the context clearly indicates otherwise.

In some exemplary embodiments, one or more data sources associated with the product may be processed, analyzed, or the like, to extract contextual information of the product's events (also referred to as “analytics events”). In some exemplary embodiments, data sources regarding a client product may comprise the source code of the product, event logs of the product (e.g., stored in the data warehouse), documentation of the product, examples of queries for the data warehouse, or the like. In some exemplary embodiments, data warehouses may be critical for many modern digital products that rely on large datasets and complex analytics. For example, a data warehouse of a product may comprise a centralized repository where analytics data of a client's product is stored and managed for analysis. In some exemplary embodiments, the data warehouse may aggregate data from multiple sources, such as event logs, application databases, other structured datasets, or the like. In some exemplary embodiments, the data warehouse may also be referred to herein as the event Database (DB), the database, the event logs, or the like.

In some exemplary embodiments, the data sources may comprise a data warehouse storing event logs. In some exemplary embodiments, event logs, stemming from digital products such as websites, applications and dashboards, may comprise an analytics database of the product, debug logs of the product, or the like. In some exemplary embodiments, the event logs may comprise raw user interactions with the product that occurred during execution of the product, e.g., as part of the development and/or deployment stages of the product. For example, historic or previous instances of user interactions, of fired events, of event sequences, or the like, may be recorded and stored within the data warehouse. In some cases, the event logs may be generated and logged by developers of the digital product, tracking interactions and journeys in the digital product. In some exemplary embodiments, the event logs may comprise a structure of events, in which each event has an event name, timing of each event, parameters with different names, and settings of different values for each parameter. In some exemplary embodiments, event logs may be stored per end user, per session of end user, or the like.

In some exemplary embodiments, the data sources may comprise source code that implements the digital product. In some exemplary embodiments, the source code may define and trigger events within the digital product. In some exemplary embodiments, the source code may reflect event definitions, function calls, and logic that determines when and how events are logged. For example, different code sections (also referred to as “code units” or “snippets”) within the source code may relate to different events, trigger events, define events, or the like.

In some exemplary embodiments, the data sources may comprise documentation data such as design documents of the product, design specifications, online descriptions of the product, project management data, visual application flows such as screenshots or video clips of the product, or the like. In some exemplary embodiments, the documentation may be provided in natural language or in semi-formal or formal specification language, and may provide an overview of the product's functionality and user interface. For example, the project management data may comprise data from project management tools (e.g., JIRA™), which may store details about software development, issue tracking such as bug fixes, development tasks of the product (e.g., feature implementation), and workflow progress.

In some exemplary embodiments, the data sources may comprise query examples of the product provided in Structured Query Language (SQL), Cassandra Query Language (CQL), or in any other query language. In some exemplary embodiments, the queries may comprise historic queries, queries previously used manually to extract data from the database, queries generated manually for the generation process of the event catalog (e.g., by a user), obtained queries from a remote source, or the like. In some exemplary embodiments, query examples may comprise pairs of natural language inquiries, matched with data queries that implement the natural language inquiries.

In some exemplary embodiments, the data sources may comprise any other data related to a digital product, such as historic queries that were applied to the warehouse, data from business intelligence tools, or the like.

In some exemplary embodiments, in addition to the data sources of the digital product, the event-based analysis may rely on synthesized or artificial data derived and generated based on the data sources. For example, synthesized data may be generated in order to enrich and/or augment the data sources, and may be utilized as part of the event-based analysis. In some exemplary embodiments, synthesized data may be generated by extracting and processing event-based data from the data sources. In some exemplary embodiments, “product data”, as used herein, may refer to both the data sources and the synthesized data.

In some exemplary embodiments, the event-based analysis may be performed by automatically processing at least a subset of the product data, to extract a context of product events. In some exemplary embodiments, a context of an event may refer to the meaning or explanation of each event in the product data, its relationship with other events, when the event is defined, when the event is fired, the meaning or explanation of the different event parameters, the meaning or explanation of different values of an event parameter, the meaning or explanation of each significant value of the event parameters, or the like. In some exemplary embodiments, the event-based analysis may be configured to perform a three-tier extraction of event context, including extracting the meaning of each event, its parameters, and the significant values of those parameters.

In some exemplary embodiments, in order to extract a context of an event, the product data must be interpreted and understood. In some exemplary embodiments, performing context extraction from product data is not trivial. For example, understanding the context of event-based data is typically performed as a manual analysis by product analysts or product managers in the company. In some exemplary embodiments, in order to automatically perform context extraction from product data, multiple challenges must be addressed, such as processing various types of product data with different formats and complexities, performing complex semantic analysis tasks, complying with technical limitations of semantic analysis tasks, complying with technical limitations of language models, or the like.

In some exemplary embodiments, the event-based analysis may incorporate one or more machine learning algorithms, such as language models, advanced algorithms, heuristics-based algorithms, or the like, to perform an automated context extraction of product events from the product data. In some exemplary embodiments, the language models may possess semantic analysis and text generation capabilities, making them suitable for providing content-aware output based on textual inputs.

In some exemplary embodiments, the language models may comprise one or more Artificial Intelligence (AI) language models, such as Large Language Models (LLMs), Small Language Models (SLMs), a Generative AI models (GAIMs), Machine Learning (ML) models, or the like, which may or may not be combined with one or more heuristic engines, Natural Language Processing (NLP) models, or the like. In some exemplary embodiments, a language model such as an LLM engine may comprise a private LLM, a private tenant in a cloud or other remote server, a public LLM such as public Generative Pre-trained Transformers (GPTs), a public LLM that is re-trained on a private dataset such as an internal knowledge base, an on-premise LLM, or the like. In other cases, any other algorithms and/or machine learning models may be used.

In some exemplary embodiments, the language models may be exploited, utilized, fine-tuned, or the like, for implementing the event-based analysis. In some exemplary embodiments, the language models may be used to generate an “event catalog” that represents a context of each product event. For example, the event catalog may be generated to comprise enumerated events and their semantic description. As another example, the event catalog may be generated to comprise a semantic description of event parameters and their significant values. For example, a significant value may refer to parameter values that hold meaningful distinctions in the data, e.g., key states, categories, or thresholds. For example, a parameter such as “action_type” may have multiple values, but only certain values, such as “purchase_completed” or “subscription_canceled”, may be considered significant because they denote critical user actions. As another example, a continuous parameter with values ranging from 0-50 may have two critical values: the value of ‘0’, indicating that the parameter is void, or a value greater than zero, indicating the measured value of a non-void parameter.

In some exemplary embodiments, the event catalog may be generated as a file, document, documentation, database, spreadsheet, ledger, log, report, record, or the like, in any desired format. For example, the catalog may be generated to comprise a textual representation, a numeric representation, a graphical representation, a tabular representation, a hierarchical representation, a structured dataset, or the like, of event contexts.

In some exemplary embodiments, the event catalog may be generated based on the event-based analysis. In some exemplary embodiments, the event-based analysis may identify relevant patterns in the product data, and extract contextual information from the product data. For example, the event-based analysis may be used to assist clients with performing in-depth analysis of their product's event-based data. In some exemplary embodiments, the event catalog may be generated based on raw data sources and/or synthesized or processed data that is derived from the raw data sources.

In some exemplary embodiments, the data analysis platform may generate synthesized or processed data, such as inferred data flows, based on the product data. For example, the data analysis platform may generate call graphs based on the source code, events graphs based on event logs, summaries of code units based on the source code, summaries of events based on event logs and/or events graphs, or the like.

In some exemplary embodiments, the event catalog may be generated based on the source code of the digital product, synthesized data derived from the source code, or the like. For example, a data analysis platform that deploys one or more language models, may obtain the source code, or access to the source code remotely, from a client (such as the product owner). According to this example, the data analysis platform may process the source code, e.g., by a language model, to extract an estimated meaning of each function, class, code unit, or the like. For example, a language model may be tasked with generating a high-level textual description or summary of each code section (e.g., function, class, or the like) in the source code.

In one scenario, source code files of the product may be iteratively provided to language models, instructing them to generate a summary of each code unit, file, or the like. For example, a language model may obtain the source code, or portion thereof, as part of a prompt with an instruction to generate a general summary paragraph for each code unit that is not necessarily event-focused, to generate an event-focused summary for each code unit, or the like. According to this example, the language model may output a paragraph or any other text string for each code unit of the source code, e.g., for each function, class, or the like. In some cases, the summaries may be incorporated within the source code (e.g., as comments), stored separately from the source code, or the like. In some exemplary embodiments, one or more analysis tools or compilers may be used to extract or generate a call graph from the source code, such as in order to represent the relationships between functions and identify which functions invoke others.

In some exemplary embodiments, the event catalog may be generated based on the event logs of the digital product. In some exemplary embodiments, the event logs may be retrieved from a storage of a client, e.g., a data warehouse of the client, which may store event logs locally, on a cloud, or the like. For example, a data analysis platform that deploys one or more language models, may obtain access to the event logs of a client, such as by accessing the data warehouse of the client. According to this example, the data analysis platform may process the event logs, e.g., by a language model, to extract an estimated meaning of each event, parameter, parameter values, or the like. For example, a language model may be tasked with generating a high-level textual description of each event in the event logs.

In some exemplary embodiments, the data analysis platform may generate synthesized or processed data, such as inferred data flows, based on the event logs. For example, the data analysis platform may generate a graph of events such as a Directed Acyclic Graph (DAG) of events, a non-directed graph of events, a non-graphical representation, or the like, representing a precedence relationship between the events. In some exemplary embodiments, the graph may be generated by applying one or more searches on the event logs, applying one or more rules, using a language model, or the like. For example, a graph of events may provide a graph representation of a partial order between events, the flow of events for different parameters and/or values, or the like. In some cases, the graph of events may be generated based on alternative data sources, such as visual application flows. In some exemplary embodiments, initial graphs of events may be generated per end user, per session, or the like, and a general graph of events may be generated by combining the initial graphs.

In some exemplary embodiments, the data analysis platform may process the graph of events, such as the general graph, to extract therefrom statistics regarding logged events. For example, statistical metrics that are measured may include the probability of two events to be invoked together, the probability of a first event to be fired before a second event, the percentage of times that each of two or more preceding events are invoked before a succeeding event, an average flow of events per end user or per session, or the like.

In some exemplary embodiments, the event catalog may be generated based on the documentation data of the digital product. For example, various design documents of the product, project management data, screenshots of the product, or the like, may be retrieved from an online website, from a client database, from document management systems, project management tools, cloud storage solutions, or the like, and processed to extract event data such as enriched event context, functionalities of the product, the intended usage of the product, or the like.

In some cases, a language model of the data analysis platform may be tasked with generating synthesized data, such as a high-level textual description of one or more events, in view of event data inferred from the documentation data. For example, the high-level textual description may be generated, or enriched, similarly to the generation of high-level textual description that is performed for the event logs. According to this example, the high-level textual description may be generated independently of the event logs analysis or in combination therewith (e.g., by enriching the high-level textual description of events that is inferred from the event logs). In some cases, one or more data flows, representing a precedence relationship between events, may be inferred from the documentation data. For example, the documentation data, such as recorded end user interactions with the product, may provide an overview of the product's functionality and user interface, and the documentation data may be processed to determine why certain events are fired, when they are fired, and what is the meaning of the events with respect to the product's overall functionality.

In some exemplary embodiments, the event catalog may be generated based on exemplary queries to a database, e.g., the data warehouse of the product. As another example, exemplary queries may be provided manually by users of the data analysis platform, generated automatically such as based on historic queries, or the like. For example, exemplary queries may enable to determine the structure of data records in the database, the relationships between different data points (e.g., events, parameters, and values), how this data is applied to retrieve requested data, a required format for queries, or the like.

In some exemplary embodiments, the event catalog may be generated based on business intelligence data, such as data extracted from business intelligence tools. For example, business intelligence data may enable to enrich summaries of events, code units, or the like. As another example, business intelligence data may enable to enrich prompts to language models configured to implement data analysis tasks.

In some exemplary embodiments, the event catalog may be generated according to one or more algorithms, schemes, or the like, such as based on a combination of one or more of the above types of product data.

In some exemplary embodiments, a list of events of the digital product may be identified and extracted from the data warehouse or from any other data source, e.g., using a string search, log parsing, or the like. In some exemplary embodiments, for each event, a firing function that fired the event may be identified. For example, the firing function may be identified in the source code, or in any other location, such as by using a string search, a regular expression search, or the like. For example, a search algorithm may be executed over the source code, over the summaries, or the like, to identify the firing function. As another example, a language model may be instructed to identify the firing function of the event based on event logs in the data warehouse.

In some exemplary embodiments, after identifying the firing function of an event, the call graph may be iterated backwards to identify a chain of functions, events, code units, or the like, leading to the firing function. For example, one or more chains of functions that eventually invoke the firing function may be extracted based on the call graph, and a language model may be instructed to analyze the chain of functions, summaries of the functions, or the like, and to output an explanation or summary of the meaning of the event in the context of the previous functions. For example, the language model may be instructed to generate the explanation based on the high-level summaries of the chain of functions.

In some exemplary embodiments, in the absence of a call graph, the explanation may be generated based on the event logs, the events graph, or the like, such as by instructing a language model to explain an event in view of the events graph, summaries, or the like.

In some exemplary embodiments, in addition to generating an explanation of each event, the parameters of each event, and one or more values of each parameter may be analyzed. In some exemplary embodiments, for each parameter or parameter value of an event, the generating function that generates the parameter may be identified, e.g., using a string search over the source code, the call graph, or the like.

In some exemplary embodiments, after identifying a generating function of the parameter, the call graph may be iterated backwards from the generating function, to analyze a first chain of functions leading to the generating function. In some exemplary embodiments, the call graph may be iterated forwards from the generating function, such as to identify one or more second chains of functions propagating the parameter and potentially affecting additional events by values of the parameter. For example, at least one of the second chains may reach the firing function of the event. In some exemplary embodiments, a full context of the parameter may be extracted based on the first and second chains of functions. For example, the language model may be instructed to generate the explanation of the parameter and/or its values based on high-level summaries of the functions in the first and second chains, of affected events, of associated source code, or the like.

In some exemplary embodiments, in the absence of a call graph, the explanation of parameters and their values may be generated based on the event logs, the events graph, or the like, such as by instructing a language model to explain a parameter or parameter value in view of the events graph, summaries, or the like.

In some exemplary embodiments, the event catalog may be generated to include, for each event, a description of the meaning or context of the event. In some exemplary embodiments, for each parameter of the event, the event catalog may be generated to describe the meaning or context of the parameter. In case the parameter has significant values, the meaning of such values may be incorporated into the catalog, such as within the parameter entry, a sub-entry thereof, or the like.

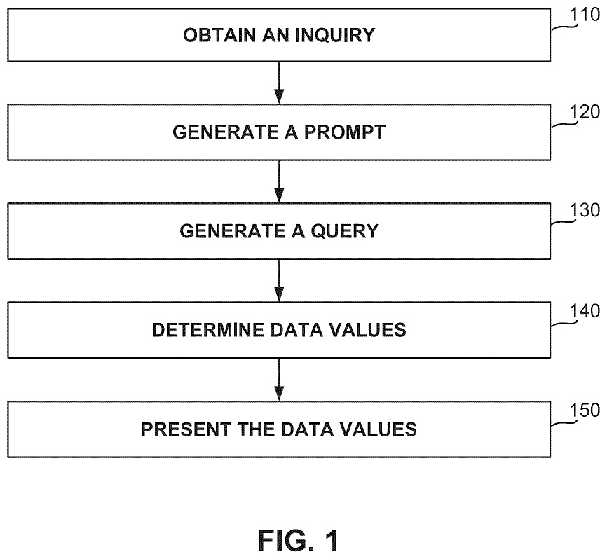

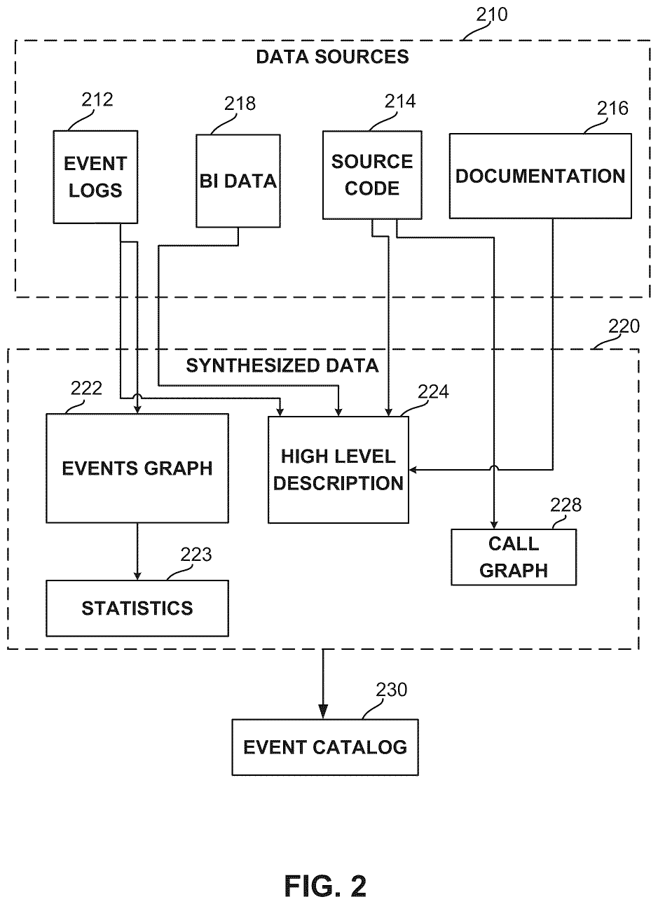

In some exemplary embodiments, at a first stage, one or more language models may generate synthesized data for respective data sources, and at a second stage, the synthesized data may be used to generate the event catalog, such as according to the above algorithm, according to the methods of FIG. 1, FIG. 2, or the like. For example, utilizing synthesized data may enable to comply with a prompt size constraint of various language models, which may restrict the ability to provide large volumes of data in the prompt.

In some cases, not all the data sources, including synthesized data inferred therefrom, may be used for the generation of the event catalog. For example, in case the source code is not accessible to the data analysis platform, the event catalog may be generated based on the event logs, the documentation, or the like.

In some exemplary embodiments, after the event catalog is generated and stored, it may be used for various data analysis tasks. In some exemplary embodiments, the event catalog may be used for providing clients with answers to data-driven inquiries, client-side questions, or the like. In some exemplary embodiments, the event catalog may be used for serving automated product-derived insights, alerts, or the like, such as without user input. In some exemplary embodiments, the event catalog may be used for automated maintenance of the client's data warehouse, for identifying critical events such as anomalies in the data, or the like.

For example, the event catalog may function as a basis for generating an SQL query to serve a client-side inquiry. For example, a product manager that works on a digital product may submit a free-text inquiry regarding the product, e.g., its usage, performance, or the like. According to this example, a first language model may be configured to obtain the inquiry, and generate a prompt for a second language model that incorporates relevant information for generating a prompt for extracting the requested data. For example, the first language model may be configured to obtain the inquiry, and generate based thereon a prompt that incorporates the free-text inquiry, the event catalog, query examples, event statistics, business intelligence data, or the like. According to this example, the generated prompt may be provided to the second language model, which may be configured to generate a data query, such as an SQL query, according to the prompt. The generated data query may be used, by a software agent of the data analysis platform, to extract the requested data from the product's database, e.g., the data warehouse, and generate an output that can be presented to the user.

As another example, instead of a free-text inquiry, a user may select a structured inquiry, such as a pre-defined inquiry that is frequently asked. For example, a frequently asked inquiry may be “what is the average duration of an end user session”. The frequently asked inquiry may comprise a pre-prepared base query, e.g., an SQL query, configured to extract the requested data from the data warehouse. In some cases, the base query may be applied automatically to the database, to extract the requested data records, without requiring to perform an LLM session to generate the query or the prompt. For example, using a pre-prepared base query may reduce the number of language model executions, make them redundant, or the like, thereby enhancing the speed and efficiency of the inquiry processing. In other cases, the user may select one or more filters for the structured inquiry, such as a date filter. In such cases, a language model execution may be performed, such as in order to incorporate the requested filter into the pre-prepared base query. For example, the language model may be provided with the structured inquiry, the base query, and the filter, and generate an SQL query that incorporates the filter in the base query.

In some exemplary embodiments, after an SQL query is generated by a language model for the respective question, the SQL query may be applied to the client's data, such as to the data warehouse. In some exemplary embodiments, the compliant data records that comply with the SQL query, or processed data values thereof, may be extracted from the client's data, and used to generate an answer. For example, the answer may be generated to explain the data records, to present the data records in one or more visual representations, graphs, or the like, to present validation data, or the like. For example, the answer may be generated to incorporate validation data that presents an overview of the generated SQL prompt, in-depth explanation to the meaning of different parts of the SQL query, its events, or any other explanation that may be useful to gain user trust.

In some cases, in order to comply with prompt size constraints, and avoiding excessively long prompts that reduce the output accuracy and increase the processing time and resource consumption, the generation of prompts may be optimized. In some exemplary embodiments, the generation of prompts may be adjusted by shortening their length. As an example, prompts may be generated to incorporate a subset of the event catalog, instead of sending the entire catalog, thereby saving time, enhancing accuracy, and enhancing the performance. For example, a machine learning predictor may be trained to obtain an inquiry and identify which event entries from the event catalog are relevant to the inquiry. The relevant event entries may be extracted from the event catalog and incorporated in the prompt, instead of incorporating the entire catalog.

One technical effect of utilizing the disclosed subject matter is enabling automatic context extraction of events of digital products. In some exemplary embodiments, the disclosed subject matter performs an in-depth analysis that extracts event contexts from various data sources for digital products of large firms, organizations, or the like.

In some exemplary embodiments, the extracted contexts enable to perform various data analysis tasks, automatically. In some exemplary embodiments, the ability to automatically deduce the meaning of analytics events and their parameters represents a transformative leap in the data analysis realm. In some exemplary embodiments, this capability opens up a multitude of applications of data analysis tasks that can fundamentally enhance how businesses and developers interact with and interpret data.

For example, the event catalog generated by the disclosed subject matter, may provide the meaning of the product's analytics events, its parameters and values, thereby representing the context of analytics events. This semantic understanding of context is crucial for addressing product-related inquiries, and for making informed decisions about both immediate and long-term product development strategies. For example, the event catalog may be used to perform efficient and accurate product data evaluation, the creation of a natural language interface for data interaction, automatic generation of insights and alerts, streamlined PRD creation, or implementing any other data analysis tasks.

Another technical effect of utilizing the disclosed subject matter is providing an improvement to manual data analysis processes, by eliminating the dependency on data scientists, or the need for extensive training of employees to manage data analysis tasks.

Yet another technical effect of utilizing the disclosed subject matter is providing a data analysis platform with increased capabilities. For example, the disclosed subject matter enables data analysis platforms to provide customer-specific functionalities using a no-code platform, without requiring the user to provide or amend SQL queries directly. By exploiting the technology of language models, such as LLM-based engines, data analysis tasks may be performed automatically for client requests, frequent requests, or the like. For example, unprecedented accuracy and efficiency may be achieved by this integration. Using the disclosed subject matter, clients may be assisted with performing data analysis tasks such as requesting the cost of an average worker above age 35, identifying a stage of digital journeys in which a highest percentage of users get stuck, or the like, efficiently and in a timely manner, which may enhance the productivity of the clients.

Yet another technical effect of utilizing the disclosed subject matter is providing a flexible context extraction framework that does not depend on all the data sources, on all the processed or synthesized data, or the like. The disclosed subject matter can use only a subset of the product data to generate a detailed data catalog that is customized for each client, each digital product, or the like. The disclosed subject matter provides an adaptive automated solution that can adapt to various event-based data formats and complexities.

Yet another technical effect of utilizing the disclosed subject matter is providing a user-friendly solution that may increase a user engagement. In some cases, a human to machine interaction may be enhanced by enabling novice no-code users to submit free-text inquiries regarding product-derived data, and to obtain automatic answers from the client's own database. For example, using the disclosed subject matter, product managers can generate meaningful insights about product usage, customer preferences, and potential issues, without programming SQL queries. As another example, using the disclosed subject matter, product databases may be made accessible via natural language inquiries of non-technical users.

Yet another technical effect of utilizing the disclosed subject matter is providing an automatic mechanism for the maintenance of event cataloging and documentation processes, or the like. For example, the process of maintaining up-to-date documentation for analytics events may be automated using a language model, ensuring that as the digital product evolves, its analytics documentation remains accurate and comprehensive. In some exemplary embodiments, automating the maintenance of event cataloging and documentation may save time, and improve the quality of data governance and compliance practices, making it easier to identify and fix data collection issues or gaps.

Yet another technical effect of utilizing the disclosed subject matter is providing an automatic mechanism for verifying the data quality and consistency of a client's data warehouse. In some exemplary embodiments, understanding the precise meaning of each event and parameter, as provided by the generated event catalog, allows to perform automated checks for data quality and consistency. For example, anomalies, redundancies, and gaps in data collection may be identified and addressed proactively, leading to a cleaner, more reliable product dataset that can support more accurate analyses and decisions. In some exemplary embodiments, context knowledge provided by the event catalog, ensures that data is collected and processed in a manner that is consistent and aligned with its intended use. In some exemplary embodiments, this reduces errors and discrepancies in data collection and analysis, leading to higher quality and more reliable data insights.

Yet another technical effect of utilizing the disclosed subject matter is providing an automatic mechanism for the extraction of product insights and alerts. In some exemplary embodiments, extracting the context of events, as performed by the disclosed subject matter, may be essential for extracting product insights and alerts. In some exemplary embodiments, the event catalog enables to perform an accurate analysis of the product data kept in the analytics tools and/or the company's data warehouse, and to obtain a better understanding of behavior of end users and their interactions within the product, leading to the identification of patterns, trends, and anomalies. In some exemplary embodiments, this enhanced analysis processes and helps identify both alerts on product problems and also opportunities in future product developments.

Yet another technical effect of utilizing the disclosed subject matter is providing an automated data analysis mechanism that utilized language models such as LLMs, while complying with prompt size constraints, optimizing prompt lengths, or the like. For example, high-level summaries may be used instead of source code or event logs, to reduce the number of characters in a prompt. The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

Referring now to FIG. 1 showing an exemplary flowchart diagram of a method, in accordance with some exemplary embodiments of the disclosed subject matter. For example, the flowchart diagram may represent a method of performing automated data analysis of a digital product. In some cases, the method may be performed automatically by a data analysis platform.

On Step 110, an inquiry regarding the digital product may be obtained. In some exemplary embodiments, the inquiry may represent a data analysis task associated with the digital product. For example, the inquiry may comprise a question regarding the performance of the product.

In some exemplary embodiments, the inquiry may be obtained from the data analysis platform, such as via a natural language interface of the data analysis platform, a structured interface of the data analysis platform that is absent of a natural language interface, or the like. For example, the inquiry may comprise a natural language question that is submitted by a user of the data analysis platform. As another example, the inquiry may comprise a selection of an inquiry via the structured interface. As another example, the inquiry may comprise a periodically generated inquiry that is executed by the data analysis platform without user input. As another example, the inquiry may comprise an automatically generated inquiry that is generated by the data analysis platform in response to an event, such as identifying an anomaly in a database of the product.

In some exemplary embodiments, the data analysis task represented by the inquiry may be performed automatically, e.g., according to Steps 120-150.

On Step 120, a prompt for a language model may be generated based on the inquiry. In some exemplary embodiments, the prompt may be generated based on event context data that is pre-prepared (e.g., according to the method described in FIG. 2), based on examples of data queries, or the like. In some exemplary embodiments, the prompt may be generated to incorporate an instruction to generate a data query such as an SQL query.

In some exemplary embodiments, the event context data may be prepared ahead of time, before inquiries such as the inquiry of Step 110 is obtained. In some exemplary embodiments, the event context data may be generated to comprise a plurality of entries, each of which representing an event of the digital product. For example, the event context data may comprise the events catalog of FIG. 2. In some exemplary embodiments, each entry may include a name of the respective event of the digital product, a textual description of the event, additional properties of the event, or the like. In some exemplary embodiments, each event entry may comprise one or more sub-entries for parameters of the event. In some exemplary embodiments, each sub-entry may state a name of the respective parameter, a textual description of the parameter, properties of the parameter, one or more values of the parameters of the event, the meaning of the values, or the like.

In some exemplary embodiments, the event context data may be generated automatically based on one or more data sources associated with the digital product, such as an events log of the digital product, documentation data regarding the digital product, source code of the digital product, business intelligence data, or the like. For example, the documentation data may comprise design documents of the digital product, online descriptions thereof, project management data, End-to-End (E2E) testing specifications for the digital product, screenshots of interactions with the digital product, video clips of interactions with the digital product, or the like. For example, online descriptions may be extracted from a web-based digital application marketplace, such as Apple App Store™.

In some exemplary embodiments, in order to generate an event entry, a call graph may be generated from source code of the digital product, to represent function invocations. For example, the call graph may represent which functions invoke one another.

In some exemplary embodiments, events of the digital product may be identified, extracted, or the like. In some exemplary embodiments, for each event, a firing function that fires the event may be identified in the source code, the call graph, or the like. In some exemplary embodiments, the call graph may be traversed from a node that represents the firing function and backwards, thereby obtaining a chain of functions that leads to the firing function, representing the context of the event.

In some exemplary embodiments, a second language model may be utilized to generate a textual description of the event based on the chain of functions. In some exemplary embodiments, the second language model may generate the textual description based on summaries generated for the chain of functions.

In some exemplary embodiments, sub-entries of the event entry may be generated. In some exemplary embodiments, in case a call graph is available, for each parameter of the event, a generating function that defines or initiates the parameter may be identified, e.g., in the source code, the call graph, the data warehouse, or the like. In some exemplary embodiments, the call graph may be traversed from a node that represents the generating function and backwards, thereby obtaining a first chain of functions that leads to the generating function. In some exemplary embodiments, the call graph may be traversed from the node that represents the generating function and forwards until reaching the node that represents the firing function, thereby obtaining a second chain of functions that leads to the firing function. In some exemplary embodiments, a textual description of the parameter may be generated, by a language model, based on the first and second chains of functions, summaries thereof, or the like.

In some exemplary embodiments, instead of using a call graph, an event entry may be generated based on an events graph. In some exemplary embodiments, the events graph may be generated based on event logs that are stored in a data warehouse of the digital product, and may represent precedence relationships between events of the digital product. In some exemplary embodiments, the second language model may be utilized to generate the textual description of the event based on the events graph, without the source code of the digital product. In some exemplary embodiments, the parameter and value entries may be generated similarly.

In some exemplary embodiments, the prompt may be generated to include all the event entries of the product, or a subset thereof. For example, entries of one or more events that are predicted by a predictor to be relevant to the inquiry, may be incorporated into the prompt, while the entries of remaining events may be omitted or excluded from the prompt.

In some exemplary embodiments, the prompt may be generated to be enriched with one or more additional data, such as with statistical data regarding the events. For example, the statistical data may be generated based on an events graph that represents precedence relationships between the events, as determined based on event logs that are stored in a data warehouse of the digital product. As another example, the prompt may be enriched with event data extracted from documentation data of the digital product. As another example, the prompt may be enriched with business intelligence data. As another example, the prompt may be enriched with queries that were previously applied to the data warehouse. In some exemplary embodiments, the prompt may be generated to be enriched with examples of data queries, such as accurate data queries that are applicable to the data warehouse of the product. For example, the examples may comprise historic examples of accurate data queries, synthesized examples such as manually or automatically generated examples, or the like. In some cases, each example may include an inquiry and a corresponding data query implementing the inquiry.

In some exemplary embodiments, the prompt may be provided or fed to a language model such as an LLM engine, a SLM engine, a GAIM, a plurality of each, a combination thereof, or the like. In some exemplary embodiments, the language model may obtain the prompt, such as via a third-party chat GUI, API calls, system calls, or any other interface.

On Step 130, based on the prompt, a data query may be generated and provided to the data analysis platform. For example, the prompt may instruct an engine of the language model to generate the data query as an output. In some exemplary embodiments, the language model may execute the prompt and provide the data analysis platform with the requested data query. For example, an LLM engine may process and/or analyze the provided prompt, and generate as an output an SQL query. For example, the processing at the LLM side may comprise performing text analysis tasks, text generation tasks, NLP processing, semantic analysis, contextual analysis, or the like.

On Step 140, data records and/or one or more values thereof may be identified, processed, determined, extracted, or the like, from the data warehouse of the digital product. In some exemplary embodiments, the data query obtained from the language model, e.g., the SQL query, may be executed over a database of the digital product, such as the data warehouse. In some exemplary embodiments, the execution may identify in the database the requested data records, process one or more values thereof, and extract one or more values or data records. For example, the data query may extract all data records that match a specific criterion. As another example, the data query may extract a sum of a specified field from all data records that match a specific criterion.

On Step 150, the data values or a representation thereof may be presented by the data analysis platform. In some exemplary embodiments, one or more data values or records may be extracted from the database and processed according to the inquiry, to generate an answer to the inquiry. In some exemplary embodiments, the answer to the inquiry may represent the one or more data values or records, and may be displayed to the user.

In some exemplary embodiments, the answer may be generated based on one or more LLM sessions, one or more non-LLM operations, a combination thereof, or the like. For example, the answer may include the data records extracted by the one or more LLM engines, extracted values associated with the records, an indication thereof, a processed version thereof, or the like.

In some exemplary embodiments, the method may function differently for structured and unstructured inquiries. For example, in case a second inquiry representing a second data analysis task is obtained from the structured interface (provided by a user or executed automatically), the data analysis platform may store a pre-prepared second data query for the second inquiry. According to this example, the second data query may be executed over the database of the digital product, to extract the requested data records or processed values from the database, without using an LLM session to generate the query. According to this example, a second answer to the second inquiry may be displayed, the answer representing the second data records or processed values thereof. According to this example, the second data analysis task may be performed with greater efficiency compared to a natural language data analysis task, at least since the second data query may be pre-prepared, validated, tested, or the like.

Referring now to FIG. 2, showing an exemplary data dependency graph, highlighting relationships and dependencies between different data elements, in accordance with some exemplary embodiments of the disclosed subject matter.

In some exemplary embodiments, one or more data sources of a digital product may be exploited to generate an Event Catalog 230. In some exemplary embodiments, Event Catalog 230 may be generated in advance, as part of a pre-processing stage. For example, Event Catalog 230 may be created prior to executing various operations, such as automated processing and responding to user inquiries, as automated maintenance of up-to-date documentation for analytics events, automated data quality and consistency checks, automated extraction of product insights and alerts, or the like. For example, it may not be possible to perform such operations automatically without having a deep understanding of event contexts, such as the understandings provided by Event Catalog 230.

In some exemplary embodiments, the pre-processing stage may comprise gathering and analyzing data from one or more data sources associated with the digital product, e.g., Data Sources 210. For example, the pre-processing stage may comprise retrieving Event Logs 212 from a backend of the digital product, e.g., a data warehouse thereof. For example, Event Logs 212 may be stored in a data warehouse, such a data warehouse of Google BigQuery™. In some exemplary embodiments, the pre-processing stage may comprise retrieving events from the data warehouse.

In some exemplary embodiments, Event Logs 212 may comprise an analytics database of the product, debug logs of the product, recorded instances of journeys and interactions with the product by developers or end users, transactional data, user activity logs sent to an analytics service, business metrics, or the like. In some exemplary embodiments, Event Logs 212 may be stored in a backend of the product, such as in one or more databases, repositories, or the like, and may comprise event logs per end user, event logs per sessions of end users, or the like. For example, Event Logs 212 may relate to an end user's activity, a relative order between events, or the like.

In some exemplary embodiments, Data Sources 210 may comprise, in addition to Event Logs 212, one or more additional data sources such as Documentation 216, Source Code 214, Business Intelligence Data 218, positive examples of data queries, or the like.

In some exemplary embodiments, Documentation 216 may comprise product descriptions, application descriptions, design specifications, design documents, project management data such as data from project management tools, or any other documentation. In some exemplary embodiments, Documentation 216 may comprise visual application flows, such as visual records of the product's flow, of user interactions therewith, or the like. For example, visual application flows may comprise screenshots of application flows, clips of application flows, screenshots of interactions of end users with the product, video clips of interactions of end users with the product, product designs from design tools such as Figma™, or from any other design tools used for User Interface (UI) or User Experience (UX) design and prototyping, or the like. In some cases, visual application flows may provide a direct observation of journeys of end users within the product.

In some exemplary embodiments, Business Intelligence (BI) data 218 may comprise data accumulated from one or more BI tools, such as Tableau™ or Looker™. For example, BI tools may comprise software applications designed to analyze and visualize data. For example, BI tools may transform raw data into interactive dashboards, charts, reports, or the like.

In some exemplary embodiments, BI data 218 may also denote a query history of the digital product. For example, historic queries that were used in the past to extract data from the data warehouse may be included in BI data 218.

In some exemplary embodiments, the positive examples of data queries may comprise historical queries, manually generated queries, automatically generated queries, or the like, that are applicable to the database. For example, positive examples of data queries may be generated automatically and tested to verify that they enable to identify and extract data from the database (thereby constituting positive examples).

In some exemplary embodiments, the pre-processing stage may comprise generating synthesized data, such as artificial or processed data, based on Data Sources 210. In some exemplary embodiments, Synthesized Data 220 may be generated based on Data Sources 210 such as Source Code 214, Event Logs 212, or the like.

For example, for each client, Synthesized Data 220 may be generated automatically to comprise a High-Level Description 224 for each file, class, function, or other code element in Source Code 214, for each event in Event Logs 212, or the like. In some exemplary embodiments, High-Level Description 224 may be generated to comprise a high-level description of the product, of segments of the product, of code elements of the product, of events of the product, or the like. For example, a high-level description of each code element may be added as a paragraph to each class and function of Source Code 214, stored separately from Source Code 214, or the like. As another example, a high-level description of each event may be generated and stored as a separate file, document, page, or the like.

In some exemplary embodiments, High-Level Description 224 may be generated by a language model, such as a Large Language Model (LLM), which may be instructed to summarize the meaning of each code element of Source Code 214, its purpose, when the code element is used, what invokes the code element, or the like, using a high-level description, a natural language description, or the like. In some cases, each code unit in Source Code 214 may be enriched with its respective LLM-generated description, adding thereto information regarding the specific code unit that is generated from the entire file or class in Source Code 214. In some exemplary embodiments, the language model may be iteratively provided with source files or sections of Source Code 214, may be provided with the entirety of Source Code 214, or the like.

In some exemplary embodiments, High-Level Description 224 may be generated based on Event Logs 212. In some exemplary embodiments, a language model may be provided with data such as Event Logs 212, and may be instructed to summarize the meaning of each event in Event Logs 212, its purpose, its context, when the invoked, what invokes the event, or the like, such as in case Source Code 214 is unavailable or regardless thereof. For example, a list of events may be extracted from Event Logs 212, e.g., using a query, a string search, a regular expression search, a textual search, or the like, and data associated with each event in Event Logs 212 may be processed to generate a high-level description or summary thereof.

In some exemplary embodiments, High-Level Description 224 may be generated based on Documentation 216. In some exemplary embodiments, a language model may be provided with data such as Documentation 216, and may be instructed to summarize the meaning of each code element represented by Documentation 216, its purpose, when the code element is used, what invokes the code element, or the like, such as in case Source Code 214 is unavailable or regardless thereof. In some exemplary embodiments, the intended user experience of the product may be utilized to enrich the semantic context of events, e.g., as part of High-Level Description 224. For example, if Documentation 216 indicates that the product is a game with different levels, this can enable a language model to infer that an event of “level up” (identified in Event Logs 212 or Source Code 214) represents a game user reaching a new level of the game, and to incorporate such understanding within High-Level Description 224.

In some exemplary embodiments, High-Level Description 224 may be generated based on any other data, such as BI data 218, a query history of the digital product, positive examples of data queries, a combination thereof, or the like. In some exemplary embodiments, a language model may be instructed to summarize the meaning of code elements or events based on the data. In some cases, BI data 218 may comprise an interactive dashboard that displays metrics associated with the data warehouse. For example, the dashboard may be linked to one or more queries in the backend of the digital product. According to this example, a language model may be instructed to estimate event data from the dashboards and associated queries of BI data 218. For example, the language model may obtain a metric title of “revenue” that displayed on a dashboard of BI data 218 and is associated to a purchase query, enabling the language model to identify an association between a “purchase” event and a “revenue” parameter, e.g., as a parameter of the “purchase” event.

In some exemplary embodiments, instead of instructing a language model to summarize the meaning of code elements or events, or in addition thereto, the language model may be instructed to enrich an existing event summary (e.g., of High-Level Description 224) with additional context and meaning, in view of one or more of Data Sources 210. For example, High-Level Description 224 may comprise a summary of an event or code element, generated based on one or more of Data Sources 210, and a language model may be instructed to enrich the summary based on a query history of the digital product, or any other data.

In some exemplary embodiments, the language model may be instructed to enrich an existing summary of an event or code unit based on Documentation 216 such as visual application flows. For example, one or more screenshots or video records of journeys of end users within the product may be processed by a language model to pinpoint when and where specific analytics events are triggered, offering a clearer understanding of the events' relevance to actions of end users and the functionality of the product. For example, visual application flows may be processed using multi-modal models to analyze screenshots and screen recordings of flows resulting in sending of the relevant analytics event and parameters. In some cases, by examining Documentation 216, a language model may gain insights into the intended user experience and interactions of the product, which helps in understanding why certain analytics events are tracked and when they are fired. For example, visual application flows may depict event flows, invocations of analytics events and parameters, or the like.

In some exemplary embodiments, for each instruction associated with a data source of Data Sources 210, the language model may be iteratively provided with segments of the data source, may be provided with the entirety of the data source, or the like.

In some exemplary embodiments, in addition to High-Level Description 224, Synthesized Data 220 may be generated to comprise a call graph, e.g., Call Graph 228. For example, Call Graph 228 may be extracted from Source Code 214, generated based thereon, or the like. In some exemplary embodiments, Call Graph 228 may be generated to include nodes representing functions, and directed edges between nodes. For example, a directed edge between two nodes may represent that a first function represented by the first node, invokes a second function represented by the second node. In other cases, Call Graph 228 may be generated as a non-graphic representation of relationships between function invocations. In some exemplary embodiments, in order to generate Call Graph 228, Source Code 214 may be processed to extract Call Graph 228, to determine which functions send or invoke each other, or the like. For example, the processing may be performed using a static analysis, a textual search, a dynamic analysis, or the like.

In some exemplary embodiments, Call Graph 228 may be generated or enriched based on Documentation 216, such as in case Source Code 214 is unavailable. In some cases, a call graph generated based on Documentation 216 may comprise a partial call graph, a full call graph, or the like, depending on the coverage of the data in Documentation 216. In some cases, Documentation 216 may be processed to generate an events graph (not depicted), such as a graph similar to Events Graph 222. In some cases, Documentation 216 may be processed to enrich an existing events graph, such as Events Graph 222 that is generated based on Event Logs 212, or an existing call graph, such as Call Graph 228 that is generated based on Source Code 214.

In some exemplary embodiments, Synthesized Data 220 may be generated to comprise an events graph, e.g., Events Graph 222, based on Event Logs 212. For example, Event Logs 212 may be processed to generate or construct, for each end user or session, a graph of the events that occurred in the session. In some exemplary embodiments, the graph may represent an order between events that occurred. In some exemplary embodiments, based on a plurality of event graphs that are generated per session or per end user, a general events graph may be generated, e.g., an Events Graph 222, such as a cyclic graph, a directed graph, a statistical model, a DAG, or the like. For example, all orders of occurrence of events, over all end users and their sessions, may be represented by Events Graph 222. In some exemplary embodiments, Events Graph 222 may comprise a graph representation of a partial order between events, in which the nodes represent events, and directed edges between the nodes represent a precedence relationship between the events. For example, a node that represents an event may have two edges, a first edge connecting the node to a preceding node that represents a preceding event, a second edge connecting the node to a succeeding node that represents an event that succeeds it.

In some exemplary embodiments, Events Graph 222 may be generated to introduce actual encountered flows of events, as indicated by Event Logs 212. In other cases, Events Graph 222 may be generated based on other data sources, such as based on Documentation 216 (not depicted), visual application flows thereof, or the like.

In some exemplary embodiments, the data analysis platform may process Events Graph 222, such as the DAG, to infer therefrom statistics for the logged events, e.g., Statistics 223. For example, Statistics 223 may be constructed to comprise a statistical model of the events, statistical metrics, or the like. In some cases, statistical metrics that are measured for each event may include the probability of two events to be invoked together, the probability of a first event to be fired before a second event, the ratio of two or more preceding events compared to a succeeding event (e.g., the percentage of times that each of the two or more preceding events are invoked before the succeeding event), the average flow of events per end user or per session, or the like.

For example, Events Graph 222 may be processed to determine, with respect to an event A that in 20% of the times, the preceding event that was fired before event A is the preceding event A1, in 50% of the times preceding event A2 was fired before event A, and that in 30% of the times preceding event A3 was fired before event A. Statistics 223 may be generated to indicate such statistical metrics. It is noted that Statistics 223 may comprise a statistical model that is constructed as a graph, directly without the use of an intermediate data structure of a graph such as Events Graph 222. In some cases, Statistics 223 may be generated to represent a probability the occurrence of various preceding events immediately before event A, a probability the occurrence of various succeeding events immediately after event A, or the like. In some cases, Statistics 223 may be generated to represent the probability of the occurrence of preceding events within a time window from event A, the occurrence of succeeding events within a time window after event A, or the like. In some cases, Statistics 223 may be generated to represent the probability of occurrence of events within a threshold number of events (e.g., up to 10 succeeding events, up to 5 preceding events, or the like) from event A. In some cases, Statistics 223 may be generated to represent the probability of occurrence of all direct and indirect preceding and succeeding events with respect to event A. In some cases, Statistics 223 may be generated to represent orders between events, such as the “new level” event occurring always before the “end level” event.

In some exemplary embodiments, a combination of product data, e.g., Data Sources 210 and/or Synthesized Data 220, may be utilized to generate Event Catalog 230. In some exemplary embodiments, Event Catalog 230 may be generated according to one or more algorithms, such as by iterating through all identified events that are identified in Events Graph 222, Statistics 223, or any other data from Data Sources 210 and/or Synthesized Data 220.

In some exemplary embodiments, a list of events of the digital product may be identified and extracted from Data Sources 210, Event Logs 212, or the like. In some exemplary embodiments, for each identified event, one or more algorithms may be applied in order to extract the context of the event.

In some exemplary embodiments, for each identified event, a firing function (also referred to as “event function”) that fired the event may be identified, e.g., within Call Graph 228, High-Level Description 224, Source Code 214, Events Graph 222, or the like. For example, Events Graph 222 may be processed to identify a triggering event, and the firing function may be identified in Source Code 214 based thereon. As another example, a search algorithm such as a string search or a static analysis may be executed over Source Code 214 to identify the firing function of the event. As another example, a language model may be instructed to identify the firing function in Source Code 214. As another example, the firing function may be identified by locating its definition using a string search over Source Code 214, locating their initialization, locating a function that fires the event, locating events in Event Logs 212, or the like. In other cases, the firing function may be identified in any other location, within any other data of Data Sources 210 and/or Synthesized Data 220.

In some exemplary embodiments, after identifying the firing function of an event, at least a portion of Call Graph 228 may be extracted and processed. In some exemplary embodiments. For example, a chain of functions in Call Graph 228 that ends with the firing function may be parsed for processing, the entirety of Call Graph 228 may be retrieved, or the like. In some exemplary embodiments, the firing function may be identified in Call Graph 228, and Call Graph 228 may be iterated from a node that represents the firing function backwards, in order to analyze the path leading to the firing function. For example, a chain of functions leading to the firing function may be traversed by a call graph iterator.

In some exemplary embodiments, data associated with the chain of functions of the firing function may be extracted, such as from High-Level Description 224, Source Code 214, or the like, and processed. For example, summaries of code units, functions, classes, files, or the like, of the chain of functions may be extracted from High-Level Description 224, from Source Code 214, or the like. In some cases, the extracted data may be processed by a language model, which may be instructed to analyze the data and generate an explanation of the context of the event according to the obtained data. For example, the language model may be instructed to generate the explanation based on High-Level Description 224 of the chain of functions, the raw data such as the code of the chain of functions, Event Logs 212, or the like. In some cases, an entry for the event may be created in Event Catalog 230, to incorporate the generated explanation.

In some exemplary embodiments, the context of the event may be extracted in any other way, such as without using a call graph. For example, Events Graph 222 may be used instead of Call Graph 228 for generating an event explanation and embedding it within Event Catalog 230. For example, a language model may be instructed to generate the textual description of an event based on Events Graph 222, event summaries of High-Level Description 224, any other portion of Synthesized Data 220, BI data 218, Documentation 216, or the like.

In some exemplary embodiments, in addition to extracting the context of the event, the context of the event's parameters and/or values may be extracted. In some exemplary embodiments, for each identified parameter of the event, a generating function (also referred to as “param function” or “parameter function”) that generated the parameter may be identified. For example, when a specific action happens in the product (e.g., a user logs in), a respective event will be fired by the firing function. The function that directly causes or triggers the event to be fired may be considered the firing function, while the function that defines or sets parameters of the event may be considered the generating function.

In some exemplary embodiments, in order to check where else the parameter is used before being passed to the firing function, a generating function that defines or initializes the parameter may be identified. For example, a search algorithm may execute a string search or a regular expression search over Source Code 214 to identify the generating function of the parameter. As another example, a language model may be instructed to identify the generating function in Source Code 214. In other cases, the generating function may be identified in any other location, e.g., in High-Level Description 224, Call Graph 228, a combination thereof, or any other data of Data Sources 210 and/or Synthesized Data 220.

In some exemplary embodiments, after identifying the generating function, at least a portion of Call Graph 228 may be processed, parsed, or the like, to identify where the parameter propagates from the generating function. In some exemplary embodiments, Call Graph 228 may be iterated forwards from a node that represents the generating function, until reaching the firing function and potentially other functions affected by the parameter and its value. In some exemplary embodiments, in addition to reaching the firing function, Call Graph 228 may be iterated forwards to identify events that are affected by the parameter.

In some exemplary embodiments, simultaneously, Call Graph 228 may be iterated backwards from the node that represents the generating function, to identify the context, or background, of the parameter, its values, or the like. For example, Call Graph 228 may be iterated backwards from the generating function, to analyze the code units, functions, events, or the like, leading to the generating function. In some exemplary embodiments, the path of functions or code units leading to the generating function, and/or the respective summaries of High-Level Description 224, may provide context regarding the usage of the parameter and its values.

In some exemplary embodiments, one or more processing units such as call graph iterators may be used to traverse Call Graph 228 both forwards and backwards from the node that represents the generating function. In some exemplary embodiments, by traversing Call Graph 228 in both directions, the relationship between the firing function and the generating function may be determined. For example, a call graph iterator may trace a first chain of functions between the generating function and the firing function, and a second chain of functions that invoke the generating function. In some exemplary embodiments, the two chains of functions may be linked, since the parameter of the event is invoked by the firing function, to form a complete execution path from parameter definition and initialization to event firing.

In some exemplary embodiments, a language model may be instructed to generate the explanation of the parameter and/or its values based on the first chain of functions, the second chain of functions, affected events that are affected by parameter, a combination thereof, or the like. In some exemplary embodiments, a language model may be instructed to generate the explanation of the parameter and/or its values based on summaries of the first chain of functions, the second chain of functions, affected events that are affected by parameter, a combination thereof, or the like. In some exemplary embodiments, an explanation for parameter values may be generated for all values, for a subset of values, or the like.

For example, an event such as the event “screen view” may be identified in Data Sources 210 and/or Synthesized Data 220. The event “screen view” may indicate that a user views a new screen in the mobile application. According to this example, the context of the event “screen view” may be extracted, by a language model, from the path leading to the firing function, which may be identified by iterating Call Graph 228 backwards from a node that represents the firing function. According to this example, the context of the parameters of the event “screen view”, such as the parameter “user_id”, may be extracted by iterating both forward and backward from the node of Call Graph 228 that generates or defines the parameter “user_id”. For example, a language model may be prompted to provide or summarize the meaning of the parameter “user_id” based on the two chains of functions.

In some exemplary embodiments, the explanation of the parameter and/or its values may be extracted in any other way, such as without using a call graph. For example, Events Graph 222 may be used instead of Call Graph 228 for generating an explanation of the parameter and/or its values and embedding it within Event Catalog 230. For example, a language model may be instructed to generate the textual description of a parameter or its value based on Events Graph 222, event summaries of High-Level Description 224, any other portion of Synthesized Data 220, BI data 218, Documentation 216, or the like.

In some exemplary embodiments, language models that are used for extracting the context of an event or its parameter, may be provided with supplement data in addition to the respective chain of functions. In some exemplary embodiments, in addition to using Events Graph 222 and/or Call Graph 228, the language model may be instructed to generate the explanation in view of additional or supplement data from Synthesized Data 220, from BI data 218, or the like. For example, the additional data may comprise Statistics 223 regarding the events, Events Graph 222, statistical metrics from Statistics 223, or the like. As another example, the additional data may comprise data from Documentation 216 such as an application description, design documentation, Jira™ tickets, SQL queries used by analytic tools, or the like. In some exemplary embodiments, the additional data may be incorporated into a prompt provided to the language model, to enrich the prompts throughout the entire generation process of the event entry, portion thereof, or the like.

In some exemplary embodiments, the extracted context of the event and each of its parameters and/or values may be incorporated into Event Catalog 230. For example, Event Catalog 230 may be generated to comprise an entry for each event, including the name of the event, a sentence of paragraph summarizing the context and/or meaning of the event, and one or more sub-entries or separate entries for each respective parameter of the event. For example, upon selecting an event entry, the sub-entries of its parameter may be configured to be presented. In case the parameter has one or more significant values, the meaning of such values may be incorporated into the sub-entry of the parameter, such as within a column therein.

In some exemplary embodiments, the generation process of Event Catalog 230 may be performed, in one or more scenarios, according to the following exemplary pseudo code flow:
1. Iterate over source files: create a summary of each file, with context in mind (general context and/or event-seeking context). The output of this phase: a paragraph on each class and each function in the code.
2. Per event:
   a. Find the function which sends it (using search and/or LLM).
   b. Find a call graph for this function and try to explain the context of the event by analyzing (using LLM) all the code which leads to this event, including summaries generated in step 1.
3. Per parameter or value:
   a. Find the function which generates this parameter or value (by string search or similar methods).
   b. Go backwards in the call graph to understand the context of the parameter or value.
   c. Go forward in the call graph to see which event(s) are connected to this parameter or value. By going forward, we can meet with the ‘per event’ iteration which went backwards from the location in which the event was sent to the analytics service.

In other cases, the generation process of Event Catalog 230 may be performed in any other way, such as without relying on source files and/or a call graph.

In some exemplary embodiments, various stages of the generation process of Event Catalog 230 may utilize language models, e.g., different language models, partially overlapping language models, or the same language models.

In some exemplary embodiments, language models such as an LLMs may or may not have a size limit or constraint on its prompt, e.g., restricting the number of characters it can process in a single prompt. In some exemplary embodiments, shortening prompts to comply with prompt size constraints may be challenging, at least since code units of the events and their call path may be long and nested. In some exemplary embodiments, although the prompt size constraints become greater as technology advances, generating excessively long prompts may result with lower accuracy outputs from the language model, while increasing the processing time and resource consumption. For example, if a prompt is generated to include thousands of lines of code without a good structure, even if the lines of code comply with the prompt size constraint, the language model will not bring a good understanding of the code, resulting with suboptimal results.

In some exemplary embodiments, one or more measures may be taken in order to reduce the prompt sizes during the event catalog generation process. In some exemplary embodiments, the prompt sizes may be reduced, such as by implementing step 2(b) in the above algorithm, which tracks the chain of functions leading to the firing function of an event, using synthesized summaries of Source Code 214 instead of Source Code 214 itself, e.g., using Call Graph 228 and/or High-Level Description 224 for generating the prompts. For example, the chunks of source code leading up to the firing of the event may be “flattened” into a single prompt, using summaries and/or the call graph, thereby enabling to fit all the relevant data of the event into a single LLM prompt. Similarly, the prompt sizes may be reduced when tracking the chains of functions of the event's parameters.

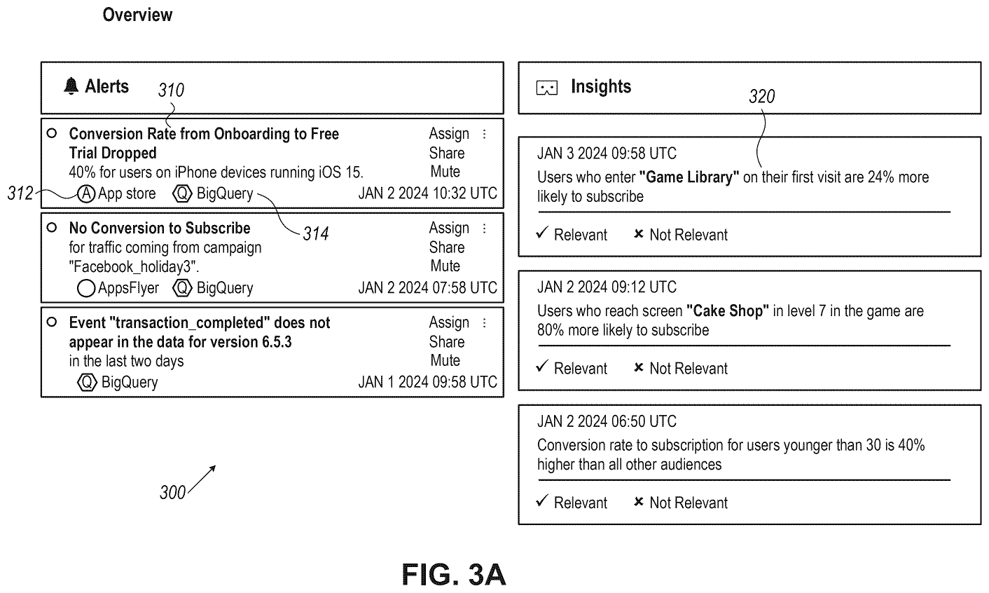

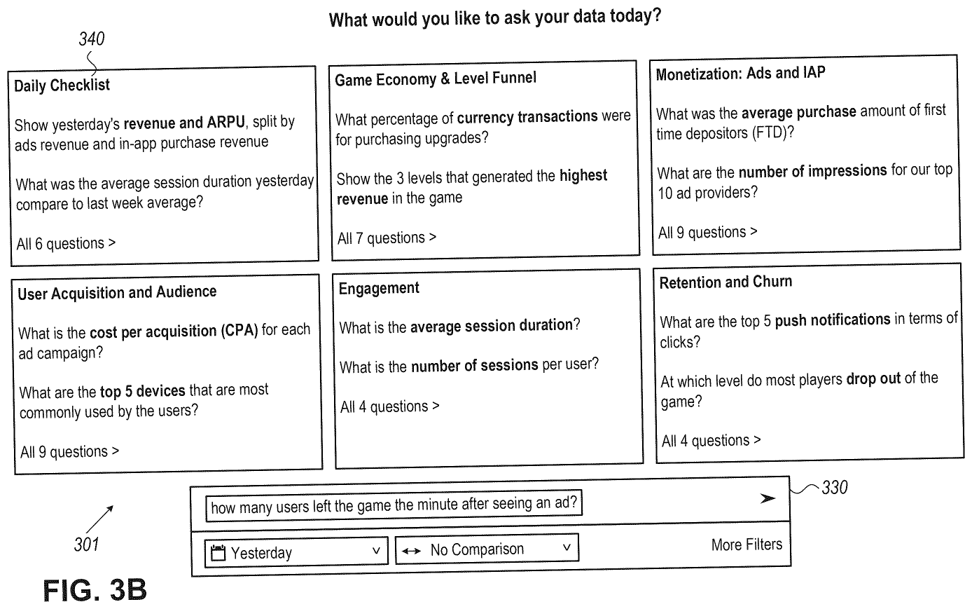

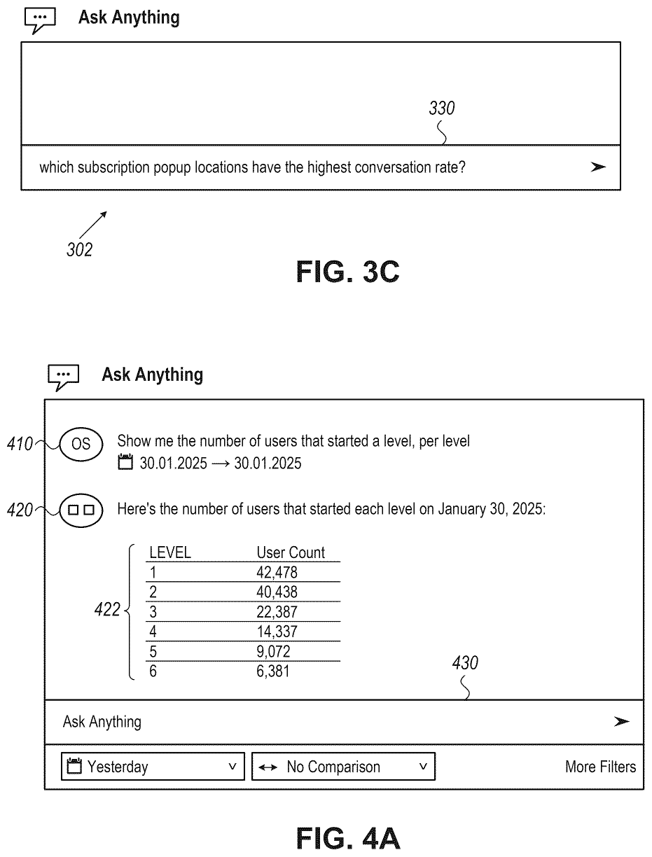

Referring now to FIG. 3A showing a schematic illustration of an exemplary insights and alerts, in accordance with some exemplary embodiments of the disclosed subject matter.

In some exemplary embodiments, Screenshot 300 of a data analysis platform may display automated data analysis results, such as alerts and insights regarding a digital product. For example, the data analysis platform may be used by a plurality of clients, to analyze their respective product data.

In some exemplary embodiments, the data analysis platform may automatically generate data-based messages such as data-based alerts generated according to a threshold, data-based insights, or the like, for each client. For example, rules for extracting data may be determined automatically for a client based on recent requests by the client, based on frequent requests made over a plurality of clients, based on frequent requests made by the current client, identified anomalies in the client's database, identified trends, identified patterns, or the like. According to this example, the rules may be applied periodically, upon an identified event, or the like, to extract matching data from the data warehouse of the client. The data may be processed and presented as data-based messages. For example, a rule may comprise a data query, a prompt for generating a data query, or the like.

In some exemplary embodiments, the extraction of product insights and alerts may be automated, e.g., using the event catalog generated according to FIG. 2. In some exemplary embodiments, understanding the context of events may be essential for extracting product insights and alerts. In some exemplary embodiments, context understanding of events, as provided by the event catalog, enables to perform an accurate analysis of the product data kept in the analytics tools and/or the company's data warehouse, and to obtain a better understanding of user behavior and interactions within the product, leading to the identification of patterns, trends, and anomalies. In some exemplary embodiments, by analyzing the data automatically using its context, product managers can generate meaningful insights about product usage, customer preferences, and potential issues. In some exemplary embodiments, this enhanced analysis processes and helps identify both alerts on product problems and also opportunities in future product developments.

In some exemplary embodiments, the display of the data-based messages may be partially or fully editable, such as by allowing users to adjust the rules for extracting data, to filter results of a rule using one or more predefined filters (e.g., a timeframe of the data), to remove a rule from the panel, or the like. In some cases, the data analysis platform may present to a user (e.g., an administrator user of a client, a product manager user, or the like) rule-based insights, alerts, or the like, as part of an “overview” tab, page, window, or the like. In some cases, insights may be presented within a dedicated “insights” tab, and alerts may be presented within a dedicated “alerts” tab.

As an example, a predefined rule of the data analysis platform may comprise an SQL query that is configured to extract a type of device and operating system of end users that has a highest drop in the conversion rate from onboarding to free trial, in case the drop is greater than a threshold. The rule may be extracted from previously generated queries, generated by a language model based on previously generated queries, or the like. In some cases, a result of applying the rule on the client's warehouse may be presented to the user in case the drop in the conversion rate is greater than a threshold, e.g., greater than 20%, 30%, or the like. As depicted in Screenshot 300, the result may be presented as an alert, e.g., Alert 310 (denoted “Conversion rate from onboarding to free trial dropped”), indicating that the conversion rate dropped by 40% for end users of the product that have an iPhone™ device running on iOS 15. In other cases, any other types of alerts may be generated, based on any other product-derived data.

In some exemplary embodiments, the data analysis platform may display, for one or more rule-based messages, which data sources were used to generate the message. For example, for Alert 310, the data analysis platform may be displayed together with the alert Data Source Indications 312 and 314, indicating that the alert was generated based on event logs of the product stored in a Google BigQuery™ warehouse of the client, and based on design documentation from a digital application marketplace such as Google Play Store™, or Apple App Store™.

In some exemplary embodiments, in addition to threshold-based messages such as alerts, the data analysis platform may generate data-based insights such as Insight 320 that are not necessarily threshold based. For example, Insight 320 may be generated automatically by applying a predefined rule, such as an SQL query that is configured to extract a segment of end users that are most likely to subscribe. According to this example, Insight 320 may be generated to indicate that end users of the product who enter “Game Library” on their first visit are 24% more likely to subscribe than otherwise. In other cases, any other types of insights may be generated, based on any other product-derived data.

In some exemplary embodiments, users may be enabled to label messages such as insights as relevant or not, thereby creating a feedback loop. In some exemplary embodiments, a relevance classifier may be trained based on selected labels, to present the most relevant insights to each client. In some cases, the classifier may be trained per client, such as in order to personalize the insights and alerts for the preferences of each client. In some cases, the classifier may be trained over all clients, such as in order to determine an overall relevance of candidate message, and present the highest scoring messages. In some exemplary embodiments, the data analysis platform may enable users to assign data-based messages to one or more employees, to share them, to mute them, to display additional data regarding alerts or insights, or the like.

Referring now to FIG. 3B showing a schematic illustration of an exemplary user interface for performing data analysis tasks, in accordance with some exemplary embodiments of the disclosed subject matter.

In some exemplary embodiments, the data analysis platform may provide an inquiry interface, such as Inquiry Interface 301, to enable users to submit natural language inquiries, to submit structured inquiries, to submit frequently asked inquiries, or the like. For example, the inquiries may enable to implement data analysis tasks.

In some exemplary embodiments, Inquiry Interface 301 may comprise a natural language text field, such as Text Field 330, enabling users to input free text therein regarding product-based data. For example, users may input to Text Field 330 a question such as “how many users left the game a minute after seeing an ad”, which may be relevant for a game product. As another example, users may input to Text Field 330 any other question or inquiry, such as “which subscription popup locations have the highest conversation rates”. In some cases, Text Field 330 may be set with one or more predefined filters, which may or may not be used. For example, the filters may limit the results to a target time window, country, platform, version, may enable to compare the results to results of different filters, or the like. In some exemplary embodiments, using Text Field 330, users can query their databases in natural language to obtain insights.

In some exemplary embodiments, the free text that is obtained from a user may be concatenated or incorporated within a predefined structure of a prompt, e.g., as defined by the data analysis platform. For example, the data analysis platform may be configured to generate a prompt to an LLM engine, asking the LLM engine to process inputs from users according to event contexts of the respective digital product, and to generate an SQL query for extracting the data that is requested from the user. In some cases, Inquiry Interface 301 may be implemented as a chat, such that a language model may provide feedback to user questions. For example, in case the user question is not clear, the language model may request from the user to clarify one or more points of his question, so that the language model may be enabled to generate a data query that matches the free text input of the user. As another example, in case the user question is not data-driven, the language model may answer directly without generating a data query.

In some exemplary embodiments, one or more language models may obtain the prompt, representing the user's question, event contexts from the event catalog, or the like, and generate an SQL query for the database. For example, the prompt may instruct a language model to generate a query, such as an SQL query, in order to extract data that complies with the user's question from the data warehouse (e.g., Google BigQuery™, Snowflake™, Amazon Redshift™). For example, the prompt may state: “answer the user's question, and if the answer requires accessing the warehouse data, return an SQL query to answer the user's question”. In some scenarios, instead of feeding the event catalog or portion thereof directly to the language model, the language model may be trained to be familiar with the event meanings, e.g., with the event catalog as generated on FIG. 2.

In some exemplary embodiments, the generated SQL query may be applied to the product's database, such as to the data warehouse, and used to retrieve and present the requested insights to the user. For example, the SQL query may be applied to the data records of the data warehouse, and the data records from the data warehouse that matches the SQL query may be extracted therefrom.

In some exemplary embodiments, the data records may or may not be further processed, such as based on the inquiry. For example, in the scenario of Alert 310, the SQL query may identify records that represent the conversion rate from onboarding to free trial for end users of the product that have an iPhone™ device running on iOS 15, and the extracted records may be processed to identify whether the rates dropped above the specified threshold. For example, the extracted data records may be extracted from the database and provided to one or more language models in order to process them and generate a presentable result to the user based on the data records.

In some cases, the presentable result may comprise one or more statistical graphs of the data records, natural language explanation of the data records, or the like. In some cases, one or more verifications may be performed before the result is presented. For example, multi-agent language models may be utilized to communicate and/or converse with one another and assist in perfecting the presentable result. For example, a multi-agent GAIM may include a “devil's advocate” agent tasked with looking for flaws in the answers provided by the other agents.

In some exemplary embodiments, Inquiry Interface 301 may comprise a plurality of structured inquiry interfaces, such as Structured Element 340, enabling users to submit requests using base queries that are pre-defined. For example, the base queries may correspond to the rules used for generating the insights and alerts of FIG. 3A, or to any other rules. In some exemplary embodiments, the data analysis platform may be designed to organize the structured inquiry interfaces into categories, such as “Daily Checklist”, “Game Economy & Level Funnel”, “Monetization: Advertisements (Ads) and In-App Purchases (IAP)”, “User Acquisition and Audience”, “Engagement”, “Retention and Churn”, or any other data analysis task categories, such that each category includes a plurality of suggested inquiries.

In some exemplary embodiments, structured inquiries may be added to Inquiry Interface 301 in case they are frequently executed by all clients, in case they are frequently executed by the current client, in case they are similar to a field of known report, in case they are predefined by the client and set as a structured element, in case they represent frequent issues with products, or the like.

For example, Structured Element 340 may comprise a “Daily Checklist” inquiry category, showing a checklist of several frequently-executed inquiries that are useful to follow on a daily basis. For example, an inquiry of Structured Element 340 may be configured to extract from the data warehouse records representing the client's revenue on the previous day, and Average Revenue Per User (ARPU), split by advertisement revenues and in-app purchase revenues. For example, in case users frequently ask for this data, an SQL query may be pre-prepared for this task and presented as a structured element. For example, the SQL base query may be predefined and verified ahead of time to accurately represent the requested data, e.g., using a set of one or more language models. In some cases, the user may be enabled to fine-tune the base query, by selecting a filter such as target time window, a target country, a target platform, a target version, or the like. For example, a language model may be used to incorporate one or more selected filters into the base query, before applying the query to the database.

Upon selection of such an inquiry, a predefined SQL query may be automatically retrieved and used to extract the requested data. In some exemplary embodiments, utilizing structured inquiries may have enhanced performance compared to natural language inquiries, at least since the base inquiries therefor may be tested, processed and verified, resulting with high accuracy outputs, quick executions of SQL queries, and potentially no need to execute language engines for generating the query.

In some exemplary embodiments, the utilization of both structured and free text inquiries may provide users with a deep understanding of the semantics behind analytics events and their parameters, allowing to dramatically lower the barrier to data analysis. For example, novice and non-technical users may be enabled to derive meaningful information and perform data analysis tasks using Inquiry Interface 301, without needing to understand complex query languages, to be trained to use query languages, or to understand the underlying data schema.

In some exemplary embodiments, the generated event catalog may provide the understanding of the semantics behind analytics events and their parameters to language models, allowing to identify the relevant events for each inquiry and to generate a data query that matches the events. It enables fine-tuning an LLM, so it can understand the semantics behind user inquiries and map them accurately to the relevant events, thus facilitating more relevant and accurate answers.

Referring now to FIG. 3C showing a schematic illustration of an exemplary inquiry interface, in accordance with some exemplary embodiments of the disclosed subject matter.

In some exemplary embodiments, Inquiry Interface 302 may comprise an alternative interface of the data analysis platform, that corresponds to Inquiry Interface 301 without the structured elements. For example, Inquiry Interface 302 may comprise a natural language text field, such as Text Field 330, to enable users to submit natural language inquiries. In some cases, the data analysis platform may incorporate both interfaces Inquiry Interface 301 and Inquiry Interface 302, such as on different tabs, pages, or the like. In other cases, the data analysis platform may incorporate one of Inquiry Interface 301 and Inquiry Interface 302.

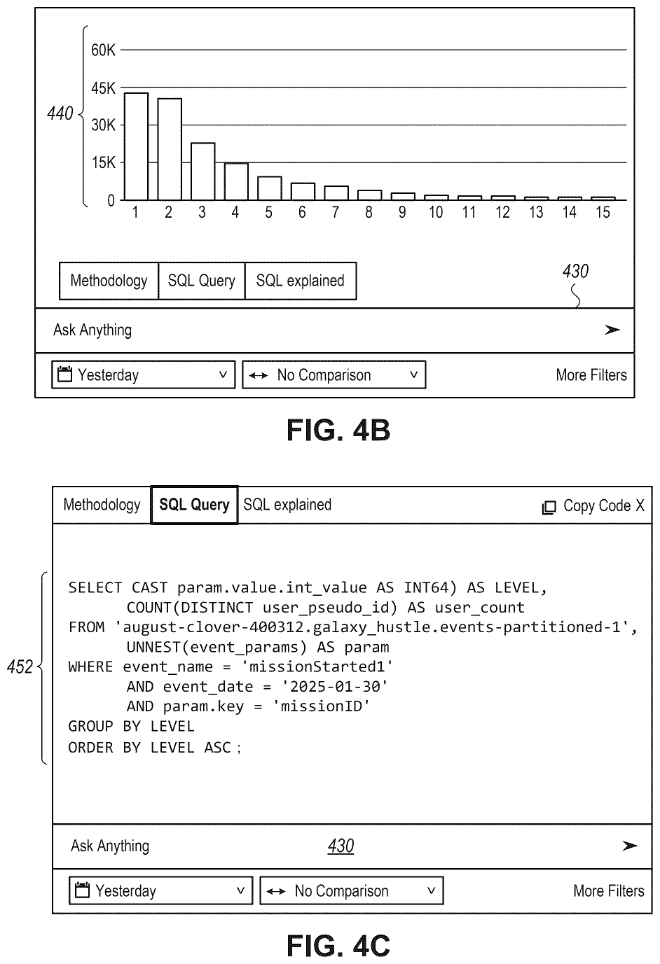

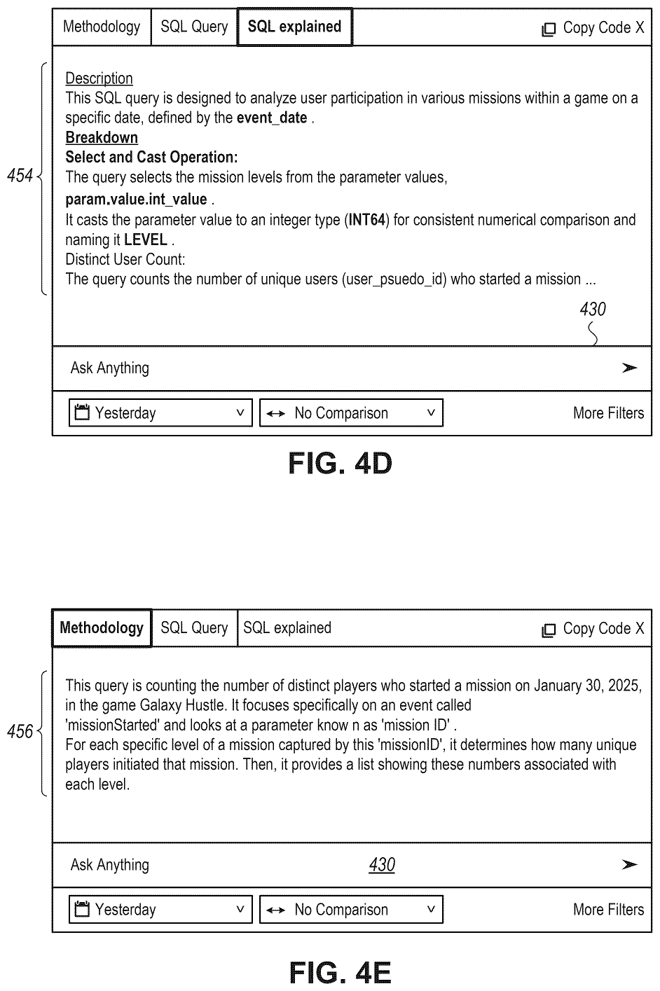

Referring now to FIGS. 4A-4E, showing exemplary results to client-initiated inquiries, in accordance with some exemplary embodiments of the disclosed subject matter.

In some exemplary embodiments, after one or more client-initiated inquiries are submitted, such as structured or natural language inquiries, the data analysis platform may retrieve data records from the data warehouse, process the data records, and present an output based thereon in one or more manners.

For example, as depicted in FIG. 4A, a client-initiated Inquiry 410 such as “Show me the number of users that started a level, per level” may be submitted, with a date filter of 30.01.2025. For example, the inquiry may be submitted in the context of a game product. In some cases, Inquiry 410 may be submitted via a natural language text field, such as Text Field 430. For example, Text Field 430 may correspond to Text Field 330 of FIG. 3C. In other cases, Inquiry 410 may correspond to a structured inquiry, an insight, alert, or the like.

In some exemplary embodiments, Inquiry 410 may be fed as a prompt to a language model, together with context data such as an event catalog, examples of applicable data queries, or the like. In some exemplary embodiments, the context data may comprise static and/or pre-prepared data, such as the event catalog or portion thereof. For example, a predictor may estimate which event entries (and potentially which parameter sub-entries) are relevant to Inquiry 410, and include only those entries into the prompt. The event catalog information may be used for providing a context to the language model, so that the data query will be generated accurately.

In some cases, the context data may comprise applicable examples of data queries, such as user inquiries and correct transformations of the inquiries into SQL queries that can be utilized to extract the relevant data. For example, the query examples may be used for training the language model to define applicable SQL queries that match the format of the specific data warehouse of the client, that is relevant to the requested information, or the like. In some cases, data regarding the database scheme, such as table names and meanings, field names and meaning unnesting requirements, or the like, may be provided separately from the query examples or implicitly therein.

In some exemplary embodiments, the language model may process the system prompt and output an SQL query, or any other data query, based thereon. In some exemplary embodiments, the SQL query may be configured to extract from the data warehouse the requested data. In some exemplary embodiments, extracted data obtained by the SQL query may show the number of users that started a level, per level, at the date of 30 Jan. 2025. For example, the SQL query may correspond to SQL Query 452 of FIG. 4C. In other cases, post-processing of the extracted data may be performed by the same or different language model, such as to comply with the specific user request.

In some exemplary embodiments, a result to Inquiry 410, including the extracted data or a processed version thereof, may be presented to the user, such as via a graphical display, a textual display, or the like. For example, the result may be displayed by a Text Portion 420 and a Tabular Portion 422. In some exemplary embodiments, Text Portion 420 may comprise a title or overview of the extracted data, in the current case stating:

“Here's the number of users that started each level at Jan. 30, 2025”. Tabular Portion 422 may display the extracted data in a tabular format, in which a first column represents the different levels and the second column represents the user count of end users that started the respective level at the mentioned date. In other cases, the extracted data may be displayed in any other way.

In some exemplary embodiments, the result may be displayed in one or more graphical representations, statistical representations, or the like. For example, as depicted in FIG. 4B, the extracted data of FIG. 4A may be presented in a chart such as a Bar Chart 440, or using any other representation. In some exemplary embodiments, the result may be presented automatically and without the need to consult an expert such as a data analyst, without SQL training, or the like.

In some exemplary embodiments, in order to increase user trust in the result, the data analysis platform may display the extracted data along with validation data. In some exemplary embodiments, validation data may provide validation data regarding the SQL query that was used to retrieve the response, for various technical levels of users. For example, as depicted in FIG. 4C, for a highly technical user, SQL Query 452 may display the SQL query itself that was used to retrieve the response. For example, SQL Query 452 comprises the query that was used to extract the presented data or a source thereof from the data warehouse of the respective client. In some exemplary embodiments, presenting the SQL query that was used may be performed in order to increase user trust in the result, e.g., in Tabular Portion 422 of FIG. 4A.

For example, SQL Query 452 may correspond to the following SQL query, or to any other SQL query:

```
SELECT CAST(param.value.int_value AS INT64) AS LEVEL,
  COUNT(DISTINCT user_pseudo_id) AS user_count ;
FROM ‘august-clover-400312.galaxy_hustle.events-partitioned-1’:
  UNNEST(event_params) AS param
WHERE event_name = ′missionStarted′
  AND event_date = ′2025-01-30′
  AND param.key = ′missionID′
GROUP BY LEVEL
ORDER BY LEVEL ASC
```

In some exemplary embodiments, for less technical users that are not fully trained or familiar with SQL, the data analysis platform may present the validation data as an explanation of components of the generated SQL query, in order to enhance user trust. In some exemplary embodiments, as depicted in FIG. 4D, an explanation of SQL Query 452, portions thereof, or the like, may be presented to the user as a separate tab or page element, e.g., within SQL Explained 454. In some exemplary embodiments, SQL Explained 454 may display an explanation of the SQL query, such as explaining the meaning of different parts of the SQL query in natural language or any other human understandable language. In some exemplary embodiments, SQL Explained 454 may be generated by a language model, such as by using a predefined prompt requesting the language model to explain each component of the SQL query.

In some exemplary embodiments, SQL Explained 454 may present an in-depth explanation to the meaning of different parts of the SQL query, its events, or any other explanation that may be useful to gain user trust of the response. For example, SQL Explained 454 may explain each SQL line or command, e.g., as following: “This SQL query is designed to analyze user participation in various missions within a game on a specific date, defined by the event_date. Breakdown: Select and Cast Operation: The query selects the mission levels from the parameter values, param. value.int_value. It casts the parameter value to an integer type (INT64) for consistent numerical comparison and naming it LEVEL. Distinct User Count: The query counts the number of unique users who started a mission . . . ”. For example, the “Select and Cast Operation” section may explain the first line of SQL Query 452, the “Distinct User Count” section may explain the second line of SQL Query 452, and so on.

In some exemplary embodiments, for non-technical users that are not familiar at all with SQL, the data analysis platform may present the validation data as a simplified high-level overview of the SQL query that does not necessarily relate to components of the generated SQL query. For example, a high-level overview of the generated SQL query may be generated for novice and non-programmer users. For example, as depicted in FIG. 4E, an overview of SQL Query 452 may be presented as Methodology 456. In some exemplary embodiments, Methodology 456 may be generated by a language model, such as by using a predefined prompt requesting the language model to provide a high-level non-technical explanation of the SQL query.

For example, Methodology 456 may state: “This query is counting the number of distinct players who started a mission on Jan. 30, 2025 . . . . It focuses specifically on an event called ‘missionStarted’ and looks at a parameter known as ‘missionID’. For each specific level of a mission captured by this ‘missionID’, it determines how many unique players initiated that mission. Then, it provides a list showing these numbers associated with each level.” As can be appreciated, Methodology 456 does not explain SQL Query 452 in a line-to-line basis, but instead provides a general overview of the functionality of SQL Query 452.

In some exemplary embodiments, all of SQL Query 452, SQL Explained 454, and/or Methodology 456 may be generated for all users, or, alternatively, a subset of the validation data may be generated and presented to users. For example, validation data may be presented based on a classification of the user. According to this example, in case a user is registered as a non-technical user with no SQL background, only Methodology 456 may be presented to the user.

In some exemplary embodiments, SQL Query 452, SQL Explained 454, and/or Methodology 456 may be presented according to one or more presentation configurations, such as over a page of the data analysis platform. For example, SQL Query 452, SQL Explained 454, and/or Methodology 456 may be presented as different tabs of a window, as different tabs of an inline frame (iframe), as separate page elements, as separate pages, as separate iframes, as messages within an overlay over the page's Graphical User Interface (GUI), within popup elements, tooltip elements, balloon elements, chat widget elements, or the like. In some exemplary embodiments, SQL Explained 454 and/or Methodology 456 may be generated using a language model, such as by prompting a language model with SQL Query 452, and requesting the language model to generate an explanation for each line or command of SQL Query 452, to generate an overview of the functionality of SQL Query 452, or the like.

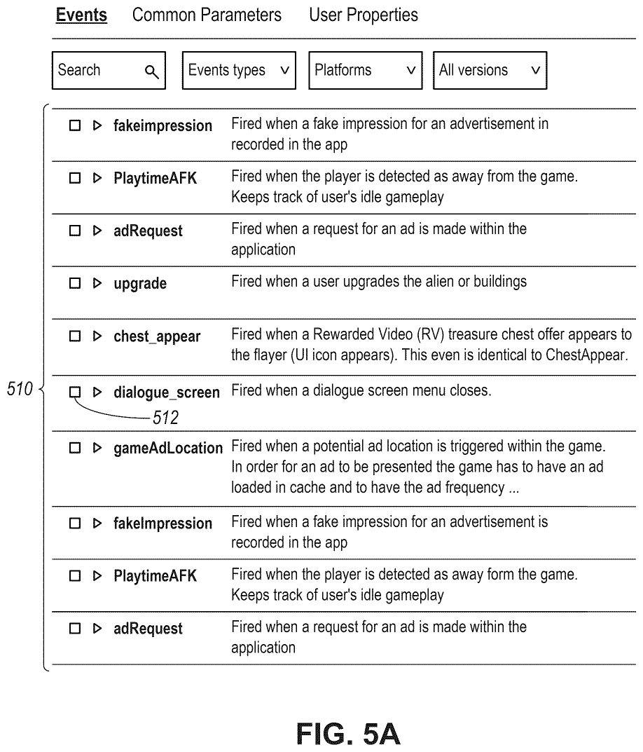

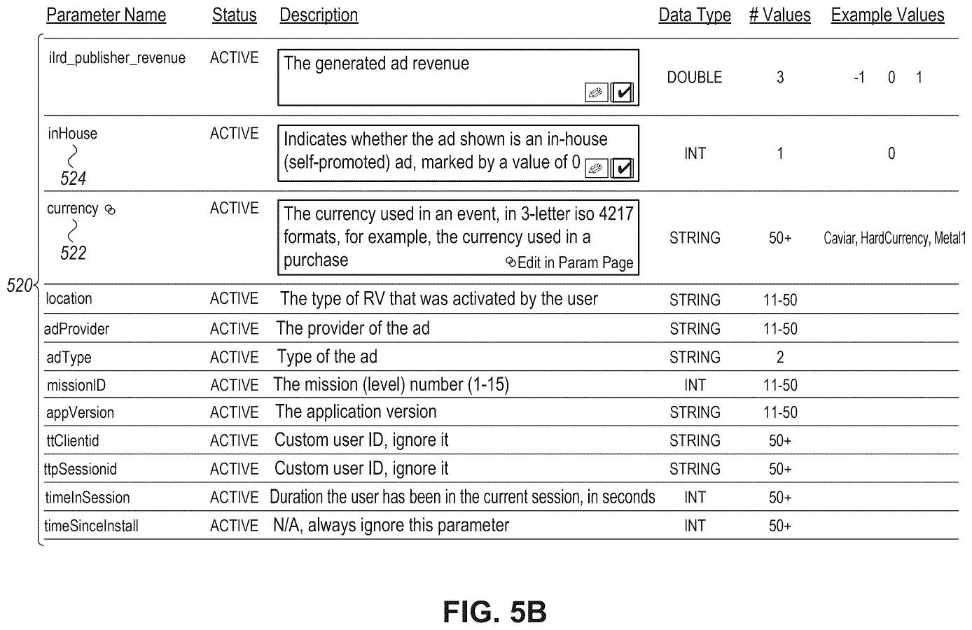

Referring now to FIGS. 5A-5B, showing an exemplary event catalog, in accordance with some exemplary embodiments of the disclosed subject matter.

In some exemplary embodiments, in order to generate an accurate SQL query for an inquiry, such as SQL Query 452 (FIG. 4C) or Inquiry 410 (FIG. 4A), context data of the respective digital product may be pre-prepared as an event catalog. For example, the event catalog may be generated according to FIG. 2 as part of a pre preparation process, before any natural language or structured inquiries are processed by the data analysis platform.

For example, as depicted in FIG. 5A, an event catalog such as Event Catalog 510 may be generated to incorporate a plurality of event entries, each entry comprising an event name, a description of the event's meaning, event versions, event platforms, event statuses, the type of event, a first recorded date in the data warehouse in which the event was fired, the last recorded date in the data warehouse in which the event was fired, a date of a last modification to the event, a number of parameters of the event, a volume of records of the event in the warehouse, or the like.

For example, for each event in the data warehouse of the product, the event name may comprise the name of the event as defined in the source code, as identified in the data warehouse, as estimated based on the data warehouse or documentation, or the like. For example, the event name may be estimated by a language model, such as according to the usage or firing of the event in the data warehouse. In some cases, the event description may comprise, for each event in the data warehouse of the product, an explanation of the meaning of the event, what causes the event to be fired, the effect of the event, or the like, e.g., in natural language.

For example, Event Catalog 510 may comprise Entry 512, representing an event that is fired when a dialogue screen menu closes on an end device that executes the product. According to this example, Entry 512 may comprise an event name, such as “dialogue_screen”. In some cases, Entry 512 may comprise an event description, generated by a language model, which may comprise a high-level description of the conditions or actions that cause the firing of the “dialogue_screen” event. For example, as depicted in FIG. 5A, the event description of Entry 512 may describe that the “dialogue_screen” is fired when a dialogue screen menu closes.

In some exemplary embodiments, Event Catalog 510 may be generated to comprise, for each event entry, data regarding the event parameters, values of the event parameters, or the like. For example, as depicted in FIG. 5B, upon selecting an event entry of Event Catalog 510, a list of the parameters of the event, such as Parameter List 520, may be presented. In other cases, Parameter List 520 of a product event may be presented in any other way, as a separate window, a page element, a separate page, or the like.

In some exemplary embodiments, Parameter List 520 of an event may present parameters that are associated with the respective event, such as parameters that are passed to the event, consumed by the event, generated by the event, or the like. In some exemplary embodiments, Parameter List 520 may include for each parameter one or more fields, such as the name of the parameter, a natural language description of the meaning of the parameter (its usage, function with respect to the event, effect, or the like), the type of parameter, its status (e.g., whether the parameter is active), its data type (e.g., a text string, an integer, or the like), the first version of the product in which it was introduced, the last version of the product in which it used, a first recorded date in the data warehouse in which the parameter was fired, the last recorded date in the data warehouse in which the parameter was fired, a date of a last modification to the parameter, names and description of significant values, a value range of the parameter, example values of the parameter, or the like. For example, the name of the parameter may be extracted from the data warehouse, the source code, or the like, e.g., similarly to the extraction of the event name.

In one scenario, Parameter List 520 may comprise one or more entries, listed items, or the like, such as Entries 522 and 524. For example, Entry 522 may represent a parameter of an event, named “currency”. For example, the description of the “currency” parameter may indicate that the parameter “currency” represents the currency used in the event, such as the currency used in a purchase, using a defined format (e.g., a 3-letter iso 4217 format). In some cases, the description of the “currency” parameter may be generated automatically, as a suggestion, such as according to the method of FIG. 2. In some cases, the description of the “currency” parameter may be editable by a client-side user. For example, an administrator user of the client may be enabled to edit the description, to save the edited version thereof, or the like.

In some cases, the entries in Parameter List 520 may be presented with a visual marking indicating whether or not they are common to other events, which may affect their editability. For example, Entry 522 may be marked as a common parameter that is linked to at least one other event, causing any edit of Entry 522 to affect other events. For example, a selection of the visual marking may cause the linked events to be presented to the user. Entry 522 may define a value range of 50+ values, all of which being of the “string” data type.

Parameter List 520 may comprise Entry 524, representing a parameter of the same event as Entry 522, that is not common to other events. In this scenario, Entry 524 may represent a parameter named “inHouse”, indicating whether an advertisement shown to an end user of the product is an inhouse advertisement or an external advertisement. In this scenario, an inhouse advertisement may be marked by a value of zero, thereby having a value range of one “integer” data type value. For example, the value of zero may be set for an inhouse advertisement, and no value may be set for non-inhouse advertisements.

In some exemplary embodiments, event cataloging and documentation processes, as well as their maintenance, may be automated. For example, specific occurrences within a product may be tracked to maintain up-to-date documentation of analytics events within Event Catalog 510. In some cases, a language model may be deployed to ensure that as the digital product evolves, its analytics documentation remains accurate and comprehensive. In some exemplary embodiments, automating the maintenance of event cataloging and documentation may save time, and improve the quality of data governance and compliance practices, making it easier to identify and fix data collection issues or gaps. For example, this may lead to Event Catalog 510 being organized, up to date, and accessible.

In some exemplary embodiments, checks for data quality and consistency may be automated, e.g., using Event Catalog 510. In some exemplary embodiments, understanding the precise meaning of each event and parameter, as provided by the generated event catalog, allows for automated checks for data quality and consistency within the data warehouse. For example, anomalies, redundancies, and gaps in data collection may be identified and addressed proactively, leading to a cleaner, more reliable database that can support more accurate analyses and decisions. In some exemplary embodiments, context knowledge provided by Event Catalog 510, ensures that data is collected and processed in a manner that is consistent and aligned with its intended use. In some exemplary embodiments, this reduces errors and discrepancies in data collection and analysis, leading to higher quality and more reliable performance of data analysis tasks.

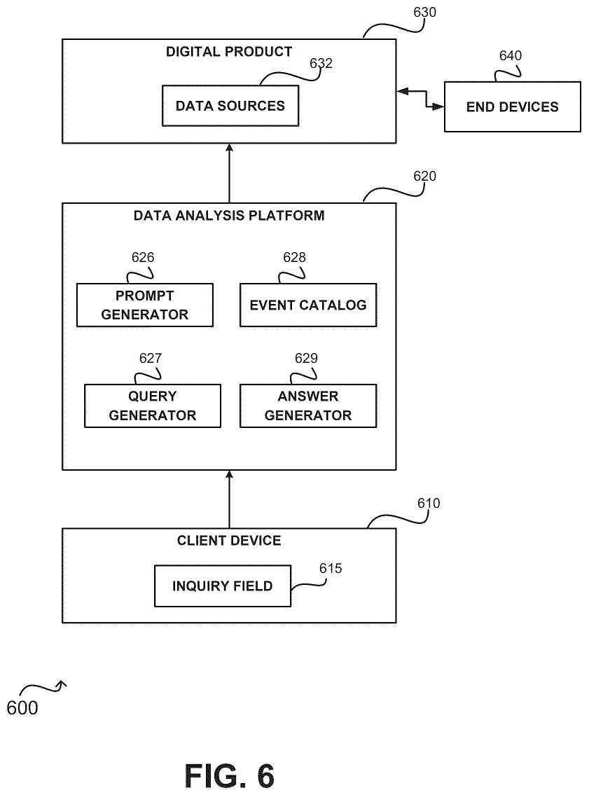

Referring now to FIG. 6 showing a schematic illustration of an exemplary architecture in which the disclosed subject matter may be utilized, in accordance with some exemplary embodiments of the disclosed subject matter.

In some exemplary embodiments, Architecture 600 may comprise a Client Device 610, which may enable one or more users associated with a client to engage with Data Analysis Platform 620. For example, the client may comprise an organization, firm, or the like, that manages at least one digital product or application such as Digital Product 630. In some exemplary embodiments, Client Device 610 may comprise laptop, a smartphone, a tablet, a Personal Computer (PC), or the like.

In some exemplary embodiments, Digital Product 630 may comprise any software product, application, Software as a Service (SaaS) platform, script, browser extension, mobile application, web application, shared library, or the like, that enables end users to perform digital tasks, digital journeys, to consume digital content, or the like. For example, Digital Product 630 may comprise a bank application, a website belonging to the client, a movie streaming application, or the like, which may be accessible to End Devices 640 of end users.

In some exemplary embodiments, a plurality of data sources may be associated to Digital Product 630. For example, Data Sources 632 may comprise the data warehouse of Digital Product 630, source code of Digital Product 630, documentations of Digital Product 630, BI data of Digital Product 630, or the like. For example, Data Sources 632 may correspond to Data Sources 210 (FIG. 2). In some exemplary embodiments, Data Analysis Platform 620 may generate synthesized data based on Data Sources 632, e.g., according to FIG. 2. In some exemplary embodiments, Data Analysis Platform 620 may extract the context of the events of the product, such as by generating Event Catalog 628, e.g., according to FIG. 2.

In some exemplary embodiments, Data Analysis Platform 620 may comprise a software application, software program, SaaS, script, browser extension, mobile application, web application, Software Development Kit (SDK), shared library, Dynamic Link Library (DLL), or the like, which may be cloud-based, a desktop application, a web-based application, an on-premise application, or the like. In some exemplary embodiments, Data Analysis Platform 620 may enable a plurality of clients that execute Data Analysis Platform 620, to perform data analysis tasks associated with their respective digital products. For example, Data Analysis Platform 620 may enable users of a first client to perform data analysis tasks associated with Digital Product 630 via Client Device 610, and may enable users of a second client to perform data analysis tasks associated with their own digital product. In some exemplary embodiments, the clients may execute Data Analysis Platform 620 on their client devices. For example, Client Device 610 may execute a frontend agent of Data Analysis Platform 620.

In some exemplary embodiments, Data Analysis Platform 620 may be separate from Digital Product 630, and may have partial or full access to Data Sources 632 of Digital Product 630. For example, Data Analysis Platform 620 may or may not have access to a backend of Digital Product 630, to the data warehouse of Digital Product 630, to its source code, or the like. For example, Data Analysis Platform 620 may be enabled to perform Application Programming Interface (API) calls to at least a portion of Data Sources 632, to directly access at least a portion of Data Sources 632, to store locally at least a portion of Data Sources 632, or the like.

In some exemplary embodiments, Data Analysis Platform 620 may define a page with one or more fields, such as an Inquiry Field 615, to be rendered on client devices such as Client Device 610. In some exemplary embodiments, Inquiry Field 615 may comprise one or more structured fields, one or more free text fields, or the like. For example, through Inquiry Field 615, Client Device 610 may enable a user to insert free style text or voice inquiries regarding Digital Product 630, to select structured inquiries, or the like. For example, a user may insert questions, using Client Device 610 that renders the page, regarding the effectiveness of an advertisement served by Digital Product 630 to End Devices 640, an average consumption rate of certain content served by Digital Product 630 to End Devices 640, or the like.

In some exemplary embodiments, Data Analysis Platform 620 may utilize one or more language models, such as LLM engines, to perform data analysis tasks according to user inputs to Inquiry Field 615. In some exemplary embodiments, Data Analysis Platform 620 may perform data analysis tasks without utilizing direct user inputs, such as by generating insights and/or alerts periodically every defined timeframe, upon detection of certain events (e.g., identifying anomalies in the database), or the like. In some cases, the language models may be hosted on-premises within Data Analysis Platform 620, in a private cloud tenant, in a public cloud, at same or different locations, potentially using different language engines for different tasks, or the like.

In one scenario, a user using Client Device 610 may enter or select an inquiry via Data Analysis Platform 620. For example, the inquiry may comprise a free-text natural language question submitted via a natural language field of Inquiry Field 615, a filter set for a structured question suggested by a structured field of Inquiry Field 615, a selection of a structured question without a filter via Inquiry Field 615, or the like. In some exemplary embodiments, the inquiry may be provided to one or more language models of Data Analysis Platform 620, such as in order to generate a data query.

For example, a Prompt Generator 626 of Data Analysis Platform 620 may obtain the inquiry, Event Catalog 628, a portion of Event Catalog 628, query examples, or the like, and generate a prompt to instruct one or more language models, e.g., language models of Query Generator 627, to generate a data query that can be applied to at least one data source of Data Sources 632. For example, Query Generator 627 may be instructed, by the prompt that is generated by Prompt Generator 626, to generate a data query that can be applied to the data warehouse of Digital Product 630. As an example, a predictor may be executed to estimate which events of Event Catalog 628 are relevant to the inquiry, and the prompt may be generated to incorporate the events from Event Catalog 628 that are estimated as relevant, while excluding the remaining entries.

In some exemplary embodiments, the generated data prompt may be fed to one or more different or same language models of Query Generator 627. In some exemplary embodiments, based on the prompt, Query Generator 627 may generate a data query, such as an SQL query that can be executed over the data warehouse of Data Sources 632.

In some exemplary embodiments, the data query generated by Query Generator 627 may be obtained by Answer Generator 629, and applied to Data Sources 632, such as to the data warehouse of Data Sources 632. In some exemplary embodiments, Answer Generator 629 may extract from Data Sources 632 the data records or values that match the data query, and generate an answer based thereon. For example, Answer Generator 629 may process the data records and generate an answer using one or more language models, e.g., language models different or identical to the previously used language models. For example, In some exemplary embodiments, Answer Generator 629 may present an output on the screen of Client Device 610, similar to FIGS. 4A-4E.

In other cases, instead of obtaining the user input directly via Inquiry Field 615, the inquiry may be automatically generated based on historic user inputs, frequently asked questions, tracked changes or anomalies in the data warehouse, or the like. For example, upon detecting an anomaly, an alert for Digital Product 630 may be automatically generated by executing a predefined inquiry, a predefined data query associated therewith, or the like.

In some exemplary embodiments, prompts may be required to comply with prompt size constraints. In some exemplary embodiments, shortening prompts to comply with prompt size constraints may be challenging, at least since a great number of event entries may be retained in Event Catalog 628, taking up large volumes of memory. Associated code units of the events and their call path may be long and nested.

In some exemplary embodiments, one or more measures may be taken in order to reduce the prompt sizes during execution of Data Analysis Platform 620, e.g., when obtaining inquiries via Inquiry Field 615. In some cases, one or more predictors may be used to estimate which events of Event Catalog 628 are relevant for the inquiry. For example, such events may be incorporated into a respective prompt, e.g., by Prompt Generator 626. In some exemplary embodiments, in order to reduce the prompt's size, events that are estimated to not be relevant to the user's inquiry may not be provided in the prompt, may be omitted therefrom, or the like. For example, Retrieval-Augmented Generation (RAG) techniques may be employed to dynamically fetch only the most relevant event entries of Event Catalog 628 instead of embedding the entire event catalog into the prompt, while maintaining completeness. In some cases, events that are deemed relevant for an inquire may be incorporated into the prompt, such as along with a copy of their relevant source code, a partial copy of their source code (e.g., source code that omits irrelevant sections such as irrelevant branches, irrelevant prefixes, or irrelevant suffixes), or the like.

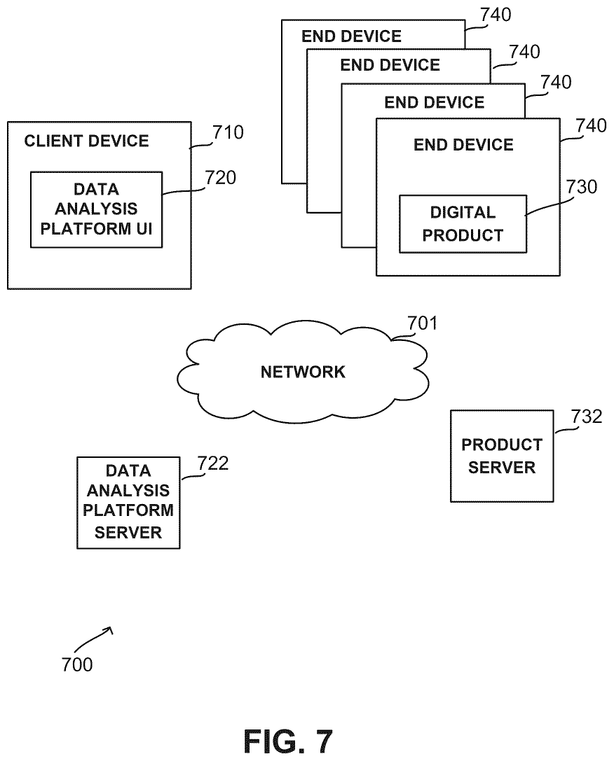

Referring now to FIG. 7 showing a schematic illustration of an exemplary environment in which the disclosed subject matter may be utilized, in accordance with some exemplary embodiments of the disclosed subject matter.

In some exemplary embodiments, Environment 700 may comprise a plurality of End Devices 740, corresponding to End Devices 640 of FIG. 6. End Devices 740 may comprise Personal Computers (PCs), stationary computers, tablets, smartphones, or the like, of respective end users. End Devices 740 may be connected to a Computerized Network 701, such as a Wide Area Network (WAN), a Local Area Network (LAN), a wireless network, the Internet, an intranet, or the like.

In some exemplary embodiments, End Devices 740 may deploy and execute a third-party application, program, or the like, e.g., Digital Product 730. For example, Digital Product 730 may comprise a web-based application, a browser extension, a mobile application, a desktop application, or the like, such as the SALESFORCE™ application, a banking application, a spelling assistance application, a walkthrough application, or the like.

In some exemplary embodiments, Digital Product 730 may or may not comprise a frontend program associated with one or more backend servers, such as Product Server 732. In some exemplary embodiments, data of Digital Product 730 may be stored in one or more data sources, such as in the data warehouse of Digital Product 730, in online design documents, or the like. Product Server 732 may correspond to Digital Product 630 of FIG. 6. For example, local SDKs of Digital Product 730 that are executed over End Devices 740 may communicate with Product Server 732 via Computerized Network 701.

In some exemplary embodiments, Environment 700 may comprise a computing device, such as Client Device 710, operated by an employee or user associated with Digital Product 730 such as a product manager working on Digital Product 730, an administrator user, a developer of Digital Product 730, a user with suitable credentials and permissions to Product Server 732, or the like. Client Device 710 may correspond to Client Device 610 of FIG. 6.

In some exemplary embodiments, Client Device 710 may deploy, execute, or the like, a Data Analysis Platform UI 720. In some exemplary embodiments, Data Analysis Platform UI 720 may correspond to a UI of Data Analysis Platform 620 of FIG. 6. In some exemplary embodiments, Data Analysis Platform UI 720 and/or the Client Device 710 that executes Data Analysis Platform UI 720 may communicate with a backend server such as Data Analysis Platform Server 722 via Computerized Network 701.

For example, Data Analysis Platform UI 720 may comprise a software platform that is configured, in cooperation with Data Analysis Platform Server 722, to enable users of Client Device 710 to perform data analysis tasks with respect to Digital Product 730 and/or its backend, e.g., as described in FIG. 6.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of performing automated data analysis of a digital product, the method comprising:
obtaining an inquiry regarding the digital product, the inquiry representing a data analysis task associated with the digital product;
performing the data analysis task automatically, said performing comprises:
generating a prompt for a language model, the prompt is generated based on the inquiry and based on event context data that is pre-prepared, the event context data comprises a plurality of entries, wherein an entry of the plurality of entries comprises a name of an event of the digital product and a textual description of the event, wherein the event context data comprises sub-entries for parameters of the event, wherein a sub-entry of a parameter comprises a name of the parameter and a textual description of the parameter, wherein the event context data is generated automatically based on one or more data sources associated with the digital product, the one or more data sources comprising at least a database of the digital product, wherein said generating comprises incorporating within the prompt an instruction to generate a data query based on the inquiry and based on the event context data;
feeding the prompt to the language model, thereby instructing an engine of the language model generate the data query in view of the prompt;
in response to said feeding, obtaining the data query from the language model;
executing the data query over the database of the digital product; and
determining one or more data values associated with the database based on said executing; and
presenting an answer to the inquiry, wherein the answer represents the one or more data values.

2. The method of claim 1, wherein the method is performed automatically by a data analysis platform.

3. The method of claim 2, wherein the inquiry is obtained via a natural language interface of the data analysis platform, the inquiry comprises a natural language question that is submitted by a user of the data analysis platform.

4. The method of claim 1 further comprising:
obtaining a second inquiry via a structured interface of the data analysis platform, the structured interface is absent of a natural language interface, the second inquiry representing a second data analysis task of the digital product;
retrieving from the data analysis platform a second data query that is configured to implement the second data analysis task, the second data query is pre-prepared by the data analysis platform;
executing the second data query over the database of the digital product;
determining one or more second data values associated with the database based on said executing the second data query; and
presenting a second answer to the second inquiry, wherein the second answer represents the second data values, whereby the second data analysis task is performed with greater efficiency compared to the data analysis task at least since the second data query is pre-prepared.

5. The method of claim 4, wherein the second inquiry is generated by the data analysis platform without user input.

6. The method of claim 1 further comprising preparing the event context data before said obtaining the inquiry, said preparing the event context data comprising:
generating a call graph from a source code of the digital product, the call graph representing function invocations;
identifying events of the digital product, the events comprising the event;
identifying a firing function that fires the event;
traversing the call graph from a node that represents the firing function and backwards, thereby obtaining a chain of functions that leads to the firing function; and
utilizing a second language model to generate the textual description of the event based on the chain of functions, wherein the second language model is identical or different from the language model.

7. The method of claim 6 further comprising processing the source code of the digital product to generate summaries of each code unit of the source code, whereby obtaining summaries of the chain of functions, and utilizing the second language model to generate the textual description of the event based on the summaries of the chain of functions.

8. The method of claim 6 further comprising utilizing the second language model to generate the textual description of the event based on an events graph that represents precedence relationships between the events, wherein the events graph is generated based on event logs that are stored in a data warehouse of the digital product, wherein the database comprises the data warehouse.

9. The method of claim 8, wherein said generating the prompt comprises incorporating in the prompt statistical data regarding the events, wherein the statistical data is generated based on the events graph.

10. The method of claim 6 further comprising utilizing the second language model to generate the textual description of the event based on at least one of: Business Intelligence (BI) data regarding the digital product as extracted from one or more BI tools, documentation data regarding the digital product, historic queries regarding the digital product, or examples of accurate data queries.

11. The method of claim 10, wherein the examples of the accurate data queries are applicable to a data warehouse of the digital product, wherein the database comprises the data warehouse, wherein the examples comprise historic examples or synthesized examples, the synthesized examples comprise manually generated examples that are provided to the data analysis platform by a user, or automatically generated examples.

12. The method of claim 10, wherein the documentation data comprises at least one of: design documents of the digital product, online descriptions of the digital product, project management data of the digital product, End-to-End (E2E) testing specifications for the digital product, screenshots of interactions with the digital product, or video clips of interactions with the digital product, wherein the online descriptions are extracted from a web-based digital application marketplace.

13. The method of claim 6 further comprising generating the sub-entry for the parameter of the event by:
identifying a generating function that defines or initiates the parameter;
traversing the call graph from a second node that represents the generating function and backwards, thereby obtaining a first chain of functions that leads to the generating function;
traversing the call graph from the second node that represents the generating function and forwards at least until reaching the node that represents the firing function, thereby obtaining a second chain of functions that leads to the firing function; and
generating the textual description of the parameter based on the first and second chains of functions or summaries of the first and second chains of functions.

14. The method of claim 1, wherein the sub-entries for the parameters of the event context data indicate one or more values of the parameters of the event and one or more textual descriptions of the one or more values.

15. The method of claim 1 further comprising preparing the event context data before said obtaining the inquiry, said preparing the event context data comprising:
generating an events graph based on event logs that are stored in a data warehouse of the digital product, wherein the database comprises the data warehouse, wherein the events graph represents precedence relationships between events of the digital product; and
utilizing a second language model to generate the textual description of the event based on the events graph, whereby enabling to prepare the event context data without the source code of the digital product, wherein the second language model is identical or different from the language model.

16. The method of claim 15 further comprising utilizing the second language model to generate the textual description of the event based on at least one of: Business Intelligence (BI) data regarding the digital product as extracted from one or more BI tools, documentation data regarding the digital product, historic queries regarding the digital product, or examples of accurate data queries.

17. The method of claim 1 further comprising preparing the event context data before said obtaining the inquiry, said preparing the event context data comprising:
utilizing a second language model to generate the textual description of the event based on Business Intelligence (BI) data regarding the digital product, wherein the BI data is extracted from one or more BI tools, wherein the second language model is identical or different from the language model.

18. An apparatus comprising a processor and coupled memory, said processor being adapted to perform:
obtaining an inquiry regarding the digital product, the inquiry representing a data analysis task associated with the digital product;
performing the data analysis task automatically, said performing comprises:
generating a prompt for a language model, the prompt is generated based on the inquiry and based on event context data that is pre-prepared, the event context data comprises a plurality of entries, wherein an entry of the plurality of entries comprises a name of an event of the digital product and a textual description of the event, wherein the event context data comprises sub-entries for parameters of the event, wherein a sub-entry of a parameter comprises a name of the parameter and a textual description of the parameter, wherein the event context data is generated automatically based on one or more data sources associated with the digital product, the one or more data sources comprising at least a database of the digital product, wherein said generating comprises incorporating within the prompt an instruction to generate a data query based on the inquiry and based on the event context data;
feeding the prompt to the language model, thereby instructing an engine of the language model generate the data query in view of the prompt;
in response to said feeding, obtaining the data query from the language model;
executing the data query over the database of the digital product; and
determining one or more data values associated with the database based on said executing; and
presenting an answer to the inquiry, wherein the answer represents the one or more data values.

19. The apparatus of claim 18, wherein the processor is further adapted to prepare the event context data before said obtaining the inquiry, said preparing the event context data comprising:
utilizing a second language model to generate the textual description of the event based on documentation data regarding the digital product, wherein the second language model is identical or different from the language model.

20. A computer program product comprising a non-transitory computer readable medium retaining program instructions, which program instructions when read by a processor, cause the processor to perform a method comprising:
obtaining an inquiry regarding the digital product, the inquiry representing a data analysis task associated with the digital product;
performing the data analysis task automatically, said performing comprises:
generating a prompt for a language model, the prompt is generated based on the inquiry and based on event context data that is pre-prepared, the event context data comprises a plurality of entries, wherein an entry of the plurality of entries comprises a name of an event of the digital product and a textual description of the event, wherein the event context data comprises sub-entries for parameters of the event, wherein a sub-entry of a parameter comprises a name of the parameter and a textual description of the parameter, wherein the event context data is generated automatically based on one or more data sources associated with the digital product, the one or more data sources comprising at least a database of the digital product, wherein said generating comprises incorporating within the prompt an instruction to generate a data query based on the inquiry and based on the event context data;
feeding the prompt to the language model, thereby instructing an engine of the language model generate the data query in view of the prompt;
in response to said feeding, obtaining the data query from the language model;
executing the data query over the database of the digital product; and
determining one or more data values associated with the database based on said executing; and
presenting an answer to the inquiry, wherein the answer represents the one or more data values.
